(19) United States
(12) Patent Application Publication
(10) Pub. No.: US 2015/0076840 A1
(43) Pub. Date: Mar. 19, 2015

(54) COUPLING DEVICE FOR RELEASABLY CONNECTING A PIVOTABLY MOUNTED BODY PART, SUCH AS A VEHICLE DOOR, TAILGATE OR HOOD TO A VEHICLE STRUCTURAL PART OF A MOTOR VEHICLE BODY

(71) Applicant: AUDI AG, Ingolstadt (DE)

(72) Inventors: Marion Schoch, Neckarsulm (DE); Bastian Rosenauer, Heilbronn (DE); Manfred Schindler, Markt Schwaben (DE)

(21) Appl. No.: 14/552,476

(22) Filed: Nov. 24, 2014

Related U.S. Application Data
(63) Continuation of application No. PCT/EP2013/001681, filed on Jun. 7, 2013.

(30) Foreign Application Priority Data
Jun. 8, 2012 (DE) 10 2012 011 420.6

(51) Int. Cl. E05B 81/00

(52) U.S. Cl. CPC E05B 81/00
USPC 292/256

(57) ABSTRACT

A coupling device for releasably connecting a pivotably mounted body part to a vehicle structural part includes a first coupling element and a second coupling element. The first coupling element has two locking bars which are configured as plate-shaped dosing wedges and are displaceable in relation to one another in a parallel manner. The dosing wedges have respective wedge faces. In order to couple the first and the second coupling element, a motorized driving device moves the locking bars apart from one another by using an operative connecting device. The second coupling element has two holding jaws, which receive the first coupling element therebetween. The holding jaws have respective keyways with respective wedge faces formed therein such that the dosing wedges are pressed into the keyways as a result of the dosing wedges being displaced apart from one another.

### CROSS-REFERENCE TO RELATED APPLICATIONS

This application is a continuation, under 35 U.S.C. §120, of copending International Application No. PCT/EP2013/001681, filed Jun. 7, 2013, which designated the United States; this application also claims the priority, under 35 U.S.C. §119, of German Patent Application No. DE 10 2012 011 420.6, filed Jun. 8, 2012; the prior applications are herewith incorporated by reference in their entirety.

### BACKGROUND OF THE INVENTION

### Field of the Invention

The invention relates to a coupling g device for releasably connecting a pivotably mounted body part, in particular a vehicle door, tailgate or hood, to a vehicle structural part of a vehicle body.

German Utility Model DE 200 03 277 U1 discloses a generic coupling device which is formed of a lock with two locking bars which are displaceable in a parallel manner in relation to one another between an open and a closed position, wherein when displacing the locking bars into their closed position they interact with a counterpart in a form-locking and/or force-locking manner for the purposes of locking. In order to move the locking bars between their open and closed position, a rotatable locking plate is provided which produces an operative connection to the locking bars through the use of crank drives. The two locking bars are moved between the open and closed position as a result of rotating the locking plate.

In addition, Published, Prosecuted German Patent Application DE 10 57 496 B describes a device for dosing motor vehicle doors which includes an electrically drivable engagement member on a door wing or on a stationary door frame and a corresponding receiving body for the drivable engagement member on the other part. In this connection, a truncated-cone-shaped locking bar can be used as an engagement member which engages in a hollow truncated cone as a receiving body. In addition, realizing such a locking bar and the associated receiving opening in a wedge-shaped manner, for example, in the form of wedge faces is also proposed.

Finally, Published German Patent Application DE 103 15 565 A1 also makes known a coupling device which is used as a so-called force joint for releasably connecting a vehicle door to a door pillar, the vehicle door being pivotally mounted on the locating side on the door pillar located there by way of a force joint. In addition, the vehicle door includes a door stiffening device connecting the force joint to the force lock such that forces from the door pillars can be introduced into the vehicle doors via the force joint and the force lock and, as a result, the rigidity of the vehicle body is increased.

The force lock described in German Patent Application DE 103 15 565 A1 for releasably connecting a vehicle door to a B-pillar of a motor vehicle body includes a first coupling element which is provided on the door side and a second coupling element which interacts with the first coupling element and is fastened on the body side, in a closed state of the force lock the two coupling elements abutting against one another in a play-free manner such that pulling and pushing forces are able to be transmitted in order, as a result, to increase the bending stiffness of the connection between the vehicle door and the B pillar and the torsional stiffness of the vehicle body. In addition, to avoid a high surface pressure and to compensate for any tolerances which can be generated by the production or in operation, holding bodies, including wedge faces, of the second coupling element are provided which cooperate with correspondingly realized wedge faces of an engagement body of the first coupling element. To form the wedge faces, the holding bodies or the engagement bodies provided on the door side are realized in the manner of cone segments or in the shape of truncated cones, four such holding bodies, for example, being arranged radially around a bolt. The tensioning of the wedge faces, that is the locking of the two coupling segments is brought about by a motorized drive or by an electromagnet, the two coupling elements being released in the event of the power supply of the drive being switched off. Realization of the known force-locking requires a high number of kinematic components which include a complicated geometry. Apart from the force lock, the vehicle door of the vehicle body additionally includes a usual door lock.

### SUMMARY OF THE INVENTION

It is accordingly an object of the invention to provide a coupling device which overcomes the above-mentioned disadvantages of the heretofore-known coupling devices of this general type. It is in particular an object of the invention to provide a coupling device that can be produced using a few, structurally simple components.

With the foregoing and other objects in view there is provided, in accordance with the invention, a coupling device for releasably connecting a pivotably mounted body part to a vehicle structural part, the coupling device including:

a first coupling element and a second coupling element, the second coupling element, in a coupled state of the coupling device, being coupled in a play-free manner with the first coupling element;

the first coupling element having two locking bars, the locking bars being mounted so as to be displaceable in relation to one another in a parallel manner, the locking bars being configured as plate-shaped closing wedges;

a cuboid closing wedge holder, the plate-shaped closing wedges being mounted in the cuboid closing wedge holder, the plate-shaped closing wedges having respective wedge faces and having a respective side edge with a respective wedge-shaped cross section for forming the wedge faces;

a motorized driving device and an operative connecting device, the motorized driving device, in order to couple the first and the second coupling element, moving the locking bars apart from one another in a motorized manner by using the operative connecting device; and

the second coupling element having two holding jaws, the holding jaws receiving the first coupling element therebetween, the holding jaws having respective keyways with respective wedge faces formed therein such that the plate-shaped dosing wedges are pressed, with the wedge faces of the plate-shaped dosing wedges, into the keyways as a result of the plate-shaped dosing wedges being displaced apart from one another in a motorized manner and thus are movable into abutment with the wedge faces of the keyways.

In other words, according to the invention, there is provided a coupling device for releasably connecting a pivotably mounted body part, in particular a vehicle door, tailgate or hood, to a vehicle structural part of a vehicle body, having a first coupling element and a second coupling element which is coupled in a play-free manner with the first coupling element in the coupled state of the coupling device, wherein the first coupling element includes two locking bars which are mounted so as to be displaceable in relation to one another in a parallel manner and there is provided a motorized driving device which, for coupling the two coupling elements, moves the locking bars apart from one another in a motorized manner through the use of an operative connecting device, is characterized according to the invention in that the locking bars are realized as plate-shaped closing wedges, which are mounted in a cuboid closing wedge holder, having wedge faces which include a side edge with a wedge-shaped cross section for forming the wedge faces, and the second coupling element is realized with two holding jaws, which receive the first coupling element between them, having keyways in such a manner that the closing wedges are pressed by way of their wedge faces into the keyways as a result of the locking bars being displaced apart from one another in a motorized manner and at the same time are able to be moved into abutment with the wedge faces of the keyways.

The coupling device according to the invention manages with a few elements, in particular only two dosing wedges are necessary, by way of which an effective form-locking is obtained between the two coupling elements, namely in all directions lying in the plane perpendicular to the wedge faces, i.e. with reference to a coordinate system of a vehicle both in the x and z direction. There is a high degree of form-locking in the direction in which the dosing wedges are moved out of the keyways.

As a result of using simple dosing wedges with keyways introduced into holding jaws for receiving the dosing wedges, a simple structural configuration is produced which can be realized in a cost-efficient manner both with regard to the production and also to assembly.

As a result of the plate-shaped closing wedges with side edges with a wedge-shaped cross section, the structural configuration is further reduced as complicated rotationally symmetrical bodies according to the prior art, such as truncated cone segments or truncated cones are omitted. Even the kinematics necessary for the two closing wedges to be displaced apart into the keyways of the holding jaws can be realized with simple measures.

In order to also allow a form-locking in the y-direction in the direction of the vehicle interior, in their longitudinal extension the keyways taper conically toward one another and the wedge faces of the closing wedges are adapted to the conical development or profile in such a manner that the insertion of the closing edges, when closing for example a vehicle door, into the second coupling element is made easier, however as a result of the longitudinal grooves of the holding jaws conically tapering toward one another in the direction of the vehicle interior and the closing wedges being adapted thereto, the two coupling elements are tensioned in this direction and consequently also allow a form-locking that enables force transmission. Thus, according to a feature of the invention, the keyways taper conically toward one another in a longitudinal extension of the keyways thus forming a conical profile; and the wedge faces of the closing wedges are adapted to the conical profile.

According to another feature of the invention, each of the dosing wedges has a side edge facing a respective one of the holding jaws; and at least one of the dosing wedges has a dosing lug on the side edge. Thus, alternatively or additionally, at least one of the dosing wedges is realized with a dosing lug on the side edge located opposite the holding jaws, which dosing lug moves into corresponding dosing openings in the keyways of the holding jaws of the second coupling element during locking. As a result, full form-locking is brought about between the two coupling elements also in the y direction, that is both in the direction of the vehicle interior and toward the outside.

According to yet another feature of the invention, the first coupling element has at least one return spring element, the at least one return spring element connects the closing wedges to one another and pretensions the closing wedges in a direction toward one another. By, according to this embodiment, the first coupling element including at least one return spring element which connects the closing wedges and pretensions the two closing wedges in the direction toward one another, the two closing wedges do not have to be actively pulled out of the tensioning with the keyways when the cam disk is rotated in the corresponding position through the use of the motorized driving device.

According to a feature of the invention, the operative connecting device for establishing an operative connection between the motorized driving device and the closing wedges of the first coupling element includes a cam disk with two diametrically opposed cam lugs; and the cam disk is mounted in the first coupling element such that, as a result of a rotation with the cam lugs and the closing wedges in operative connection, the closing wedges are pressed into the keyways of the holding jaws. In the case of this advantageous further embodiment of the invention, the operative connecting device for producing the operative connection between the motorized driving device and the closing wedges of the first coupling element includes a cam disk which has two diametrically opposed cam lugs and is mounted in the first coupling element in such a manner that, as a result of a rotation with the cam lugs and the closing wedges in operative connection, the same are pressed into the keyways.

Consequently, the dosing wedges, which are displaceably mounted in the first coupling dement, can be easily moved apart into the keyways by way of the cam disk that is disposed in between them, preferably in the plate plane of the dosing wedges, the dosing wedges moving symmetrically into the keyways of the holding jaws as a result of the oppositely located cam lugs.

According to another feature of the invention, the operative connecting device includes a control disk, the control disk is connected to the cam disk in a manner fixed against rotation relative thereto; and a stop device limits a rotation of the control disk such that the control disk is rotatable between a first position and a second position, wherein the first position decouples the first and the second coupling element and wherein the second position couples the first and the second coupling element. Thus, according to this embodiment of the invention, the operative connecting device includes a control disk which is connected non-rotatably to the cam disk, wherein through the use of a stop device the rotation of the control disk is limited in such a manner that the control disk is rotatable between a first position, which decouples the first and second coupling element, and a second position which couples the first and second coupling element.

With such a control disk, advantageous control of the motorized driving device can be realized as the limited rotation of the control disk results in a detectable change in driving parameters, such as, for example, the motor current of an electric motor as the driving device and can be utilized for switching off the driving device.

According to another feature of the invention, an entrainment device is provided; the operative connecting device has a driving disk, the driving disk is connectable to the control disk in a manner fixed against relative rotation through use of the entrainment device; the entrainment device is disposed in a pivotable and spring-loaded manner on the control disk such that the entrainment device establishes a releasable latching connection to the driving disk such that the latching connection is fixed against relative rotation; and the control disk is pivotable between the first and the second position as a result of a rotation of the driving disk, wherein the rotation is brought about by the motorized driving device. Thus, according to a further embodiment of the invention, the operative connecting device includes a driving disk which is non-rotatably connectable to the control disk through the use of an entrainment device, wherein the entrainment device is provided in a pivotable and spring-loaded manner on the control disk in such a manner that the entrainment device produces a releasable and non-rotatable latching connection to the driving disk and, as a result of a rotation of the driving disk that is brought about by the driving device, the control disk is pivotable between the first and second position.

A releasable coupling between the driving side and the driven side, which serves manually for realizing a manual emergency release, is realized by way of this entrainment device.

According to an embodiment of the invention, this is realized through the use of an emergency lever which is displaceable when operatively connected to the entrainment device in such a manner that the latching connection to the driving disk is released in the second position of the control disk and there is provided a spring element which pretensions the control disk in the direction of the first position, through the use of which the control disk is pivoted into the first position when the entrainment device is unlatched. Thus, according to a feature of the invention, an emergency lever is provided for an emergency release of the first and the second coupling element when coupled, wherein the emergency lever, when operatively connected to the entrainment device, is displaceable such that the latching connection in the second position of the control disk to the driving disk is released; and a spring element is provided for pretensioning the control disk in a direction of the first position, the spring element pivoting the control disk into the first position when the entrainment device is unlatched.

In the event of a power failure, the emergency lever is actuated through the use of a door handle, as soon as the latching connection between the control disk and the driving disk is released, the return spring elements pull the two closing wedges back out of the clamping with the keyways in the holding jaws such that, a vehicle door, for example, can be opened.

An alternative embodiment of an emergency release is created wherein a release ring, disposed axially with respect to the control disk, is provided with a control cam which can be moved into operative connection with the entrainment device for releasing the latching connection between the entrainment device and the driving disk and wherein an actuating device is provided by way of which a rotation of the release ring out of a rest position into at least one operating position is effected in such a manner that with the rotation initially the latching connection with the driving disk is released at least in the second position of the control disk and the control disk is then rotated through the use of the entrainment device in the direction of the first position thereof. Thus according to a feature of the invention, a release ring is provided for the emergency release of the first and the second coupling element, the release ring is disposed axially with respect to the control disk, the release ring has a control cam which can be brought into operative connection with the entrainment device for releasing the latching connection of the entrainment device with the driving disk; and an actuating device is configured to effect a rotation of the release ring out of a rest position into at least one operating position such that by way of the rotation initially the latching connection, at least in the second position of the control disk, with the driving disk is released and the control disk is then rotated, through use of the entrainment device, in a direction of the first position of the control disk.

This embodiment provides the advantage that an emergency release is possible even if the motorized driving device fails during the operation of coupling the two coupling elements.

In the case of this embodiment, the rotation of the release ring is preferably effected through the use of a pivotably mounted toothed segment element, in particular a toothed segment wheel or a toothed rod which meshes with a toothed segment of the release ring, the toothed segment element is pretensioned through the use of a spring in a first pivot position which corresponds to the rest position of the release ring and through the use of the actuating device, the toothed segment element is pivoted out of the first pivot position into a second pivot position which rotates the release ring in the operating position thereof. Thus, according to a feature of the invention, the release ring has a toothed segment; a toothed segment element is pivotably mounted and meshes with the toothed segment of the release ring such that the toothed segment element effects a rotation of the release ring; and the toothed segment element is spring-pretensioned in a first pivot position, which corresponds to a rest position of the release ring, and, through use of the actuating device, the toothed segment element is pivoted out of the first pivot position into a second pivot position which rotates the release ring in an operating position thereof. According to another feature of the invention, the toothed segment element is a toothed segment wheel or a toothed rod.

A Bowden cable device is provided in particular as actuating device which is pivotally mounted on the toothed segment element at the one end and is connected to a door handle of the lock at the other end. In other words, the actuating device is configured as a Bowden cable device having a first end and a second end, and wherein the Bowden cable device is linked to the toothed segment element at the first end and is configured to be connected to an actuating handle of a vehicle lock at the second end.

A particularly advantageous embodiment of the invention is provided as a result of providing an entrainment disk which is rotationally coupled with the driving disk, wherein the rotational coupling is formed by at least one play-compensating spring element which is connected at the one end to the entrainment disk and at the other end to the driving disk, and the rotational coupling allows a relative rotation between the driving disk and the entrainment disk over a predefined rotation angle in such a manner that as a result of a rotation of the entrainment disk in the direction of rotation D1 of the second position of the control disk, the driving disk is pretensioned in the same direction of rotation D1 at least when its end position is reached and a play-compensating further rotation at a maximum rotation angle that corresponds to the predefined rotation angle is made possible. Thus, according to this feature of the invention, an entrainment disk is rotationally coupled with the driving disk; and at least one play-compensating spring element is connected at one end thereof to the entrainment disk and at another end thereof to the driving disk such that a rotational coupling between the entrainment disk and the driving disk is established via the at least one play-compensating spring element, wherein the rotational coupling allows a relative rotation between the driving disk and the entrainment disk over a given rotation angle in such a manner that as a result of a rotation of the entrainment disk in a direction of rotation of the second position of the control disk, the driving disk is, at least when an end position of the driving disk is reached, pretensioned in a same direction of rotation and a play-compensating further rotation at a rotation angle which maximally corresponds to the given rotation angle is made possible.

The rotational coupling between the driving disk and the entrainment disk brings about, therefore, that in the case of a rotation of the entrainment disk that is brought about by the driving device in the rotational direction of the second position of the control disk, the driving disk is initially pretensioned until it is enough to entrain the entrainment disk in the same rotational direction into a position in which the closing wedges are tensioned in a play-free manner in the keyways, wherein in this position the play-compensating spring element presses excessively up to a stop that limits the relative rotation and as a result the spring force up to this position has increased. Should, with the driving device switched off, play be generated between the closing wedges and the holding jaws, the spring force brought about by the play-compensating spring element brings about a relative rotation of the driving disk in relation to the entrainment disk which rotates the control disk further in the direction of its second position whilst eliminating the play generated, such that, as a result, also the cam disk with its two cam lugs presses the two closing wedges further into the keyways whilst eliminating the play generated.

Consequently, when the driving device is switched off, a dynamic play compensation between the two coupling elements is obtained and, as a result, the form-locking between the two coupling elements is continuously ensured during the operation of the vehicle.

According to a further embodiment, there are provided connecting devices which enable a relative rotation of the entrainment disk in relation to the driving disk at the predefined rotation angle and consequently form a stop that limits the relative rotation. In other words, connecting devices enabling the relative rotation of the entrainment disk in relation to the driving disk at the given rotation angle are provided. A connecting pin which is connected to the driving disk and a longitudinal groove which is disposed on the entrainment disk for receiving the connecting pin are preferably provided as connecting devices in such a manner that the longitudinal groove enables a relative movement of the connecting pin corresponding to the angle of rotation. Thus, according to a feature of the invention, a connecting pin and a longitudinal groove are provided as the connecting devices, the connecting pin is connected to the driving disk, the longitudinal groove is provided on the entrainment disk for receiving the connecting pin such that the longitudinal groove allows a relative movement of the connecting pin corresponding to the rotation angle.

According to an advantageous embodiment, the entrainment disk includes a worm wheel which is driven by the motorized driving device through the use of a worm or screw. According to this feature of the invention, a worm is provided; and the entrainment disk includes a worm wheel driven by the motorized driving device via the worm. In addition, the entrainment disk includes a spring attaching wheel which, together with the driving disk receives the at least one play-compensating spring dement and includes the longitudinal groove. In other words, the entrainment disk includes a spring attaching wheel, the spring attaching wheel is formed with a longitudinal groove and, together with the driving disk, receives the at least one play-compensating spring element.

The motorized driving device is realized so as to be self-locking, in particular as an electric motor for the motorized driving of the driving disk or of the entrainment disk. Thus, according to a feature of the invention, the motorized driving device is configured to be self-locking and the motorized driving device is advantageously configured as an electric motor for a motorized driving of the driving disk or the entrainment disk.

With the objects of the invention in view there is also provided, a vehicle configuration which includes:

a motor vehicle body having a vehicle structural part and a pivotably mounted body part;

a coupling device for releasably connecting the pivotably mounted body part to the vehicle structural part;

the coupling device including a first coupling element, a second coupling element, a cuboid dosing wedge holder, a motorized driving device, and an operative connecting device;

the second coupling element, in a coupled state of the coupling device, being coupled in a play-free manner with the first coupling element;

the first coupling element having two locking bars, the locking bars being mounted so as to be displaceable in relation to one another in a parallel manner, the locking bars being configured as plate-shaped closing wedges;

the plate-shaped closing wedges being mounted in the cuboid closing wedge holder, the plate-shaped closing wedges having respective wedge faces and having a respective side edge with a respective wedge-shaped cross section for forming the wedge faces;

the motorized driving device, in order to couple the first and the second coupling element, moving the locking bars apart from one another in a motorized manner by using the operative connecting device; and

the second coupling element having two holding jaws, the holding jaws receiving the first coupling element therebetween, the holding jaws having respective keyways with respective wedge faces formed therein such that the plate-shaped closing wedges are pressed, with the wedge faces of the plate-shaped closing wedges, into the keyways as a result of the plate-shaped closing wedges being displaced apart from one another in a motorized manner and thus being movable into abutment with the wedge faces of the keyways.

According to a feature of the invention, the pivotably mounted body part is a body part such as a vehicle door, a tailgate, or a hood.

According to another feature of the invention, the operative connecting device for establishing an operative connection between the motorized driving device and the closing wedges of the first coupling element includes a cam disk with two diametrically opposed cam lugs; the cam disk is mounted in the first coupling element such that, as a result of a rotation with the cam lugs and the closing wedges in operative connection, the dosing wedges are pressed into the keyways of the holding jaws; the operative connecting device includes a control disk, the control disk is connected to the cam disk in a manner fixed against rotation relative thereto; a stop device limits a rotation of the control disk such that the control disk is rotatable between a first position and a second position, wherein the first position decouples the first and the second coupling element and wherein the second position couples the first and the second coupling element; an entrainment device is provided, the operative connecting device has a driving disk, the driving disk is connectable to the control disk in a manner fixed against relative rotation through use of the entrainment device; the entrainment device is disposed in a pivotable and spring-loaded manner on the control disk such that the entrainment device establishes a releasable latching connection to the driving disk such that the latching connection is fixed against relative rotation; a release ring is provided for an emergency release of the first and the second coupling element, the release ring is disposed axially with respect to the control disk, the release ring has a control cam which can be moved into operative connection with the entrainment device for releasing the latching connection between the entrainment device and the driving disk; an actuating device is configured to effect a rotation of the release ring out of a rest position into at least one operating position such that by way of the rotation initially the latching connection, at least in the second position of the control disk, with the driving disk is released and the control disk is then rotated, through use of the entrainment device, in a direction of the first position thereof; the release ring has a toothed segment, a toothed segment element is pivotably mounted and meshes with the toothed segment of the release ring such that the toothed segment element effects a rotation of the release ring, the toothed segment element is spring-pretensioned in a first pivot position, which corresponds to a rest position of the release ring, and, through use of the actuating device, the toothed segment element is pivoted out of the first pivot position into a second pivot position which rotates the release ring in an operating position thereof; and a vehicle lock with an actuating handle is provided, the actuating device is configured as a Bowden cable device having a first end and a second end, and the Bowden cable device is linked to the toothed segment element at the first end and is connected to the actuating handle of the vehicle lock at the second end.

Other features which are considered as characteristic for the invention are set forth in the appended claims.

Although the invention is illustrated and described herein as embodied in a coupling device for releasably connecting a pivotably mounted body part, such as a vehicle door, tailgate or hood to a vehicle structural part of a motor vehicle body, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic perspective view of a first coupling element of a first exemplary embodiment of a coupling device according to the invention;

FIG. 2 is a diagrammatic perspective view of a second coupling element, which together with the first coupling element according to FIG. 1 forms a coupling device according to the invention;

FIG. 3 is a diagrammatic perspective view of the second coupling element according to FIG. 2 with closing wedges of the first coupling element according to FIG. 1;

FIG. 4 is a diagrammatic perspective view of the coupling device according to the invention with a first and second decoupled coupling element according to FIG. 1 and FIG. 2;

FIG. 5 is a diagrammatic perspective view of the coupling device according to the invention with a closing wedge holder of the first coupling element shown in exploded form;

FIG. 6 is a diagrammatic perspective view of the coupling device according to the invention with a first coupling element shown in part in exploded form;

FIGS. 7a, 7b are diagrammatic partial views of the first and second coupling elements of the coupling device according to FIG. 4 with the closing wedges decoupled in accordance with the invention;

FIGS. 8a, 8b are further diagrammatic partial views of the first and second coupling elements of the coupling device according to FIGS. 7a, 7b with the closing wedges in the coupled position in accordance with the invention;

FIGS. 9a, 9b are diagrammatic partial views of the first coupling element according to the invention to explain the emergency release function of the coupling device according to FIG. 4;

FIG. 10 is a diagrammatic perspective view of the coupling device according to FIG. 4 with a housing that includes a load attaching element;

FIG. 11 is a schematic partial view of the region of the B pillar of a vehicle body with the coupling device according to FIG. 4 installed in accordance with the invention;

FIG. 12 is a diagrammatic side view of a coupling device as a further exemplary embodiment according to the invention;

FIG. 13 is a diagrammatic exploded view of the first coupling element according to FIG. 12 without a closing wedge holder;

FIGS. 14a, 14b are diagrammatic perspective views of the driving disk and entrainment disk according to FIG. 13 in accordance with the invention;

FIGS. 15a, 15b, 15c are diagrammatic perspective views of the first coupling element according to FIG. 12 which show the sequence of movement of the dosing wedges from a decoupled position into a coupled position in accordance with the invention;

FIGS. 16a, 16b are diagrammatic views of elements of the coupling device according to the invention for explaining the emergency release function of the coupling device according to FIG. 12;

FIGS. 17a, 17b, 17c are diagrammatic perspective views of the first coupling element according to FIG. 12 which show the sequence of movement of a manual emergency release function in accordance with the invention;

FIGS. 18a, 18b are diagrammatic perspective views of the first coupling element according to FIG. 12 which show the sequence of movement of a motorized locking operation after a manual emergency release function has been carried out in accordance with the invention;

FIG. 19 is a diagrammatic perspective view of a closing wedge with a closing lug according to the invention;

FIG. 20 is a diagrammatic perspective view of an alternative second coupling element with a displaceable cover according to the invention;

FIG. 21 is a diagrammatic perspective view of a closing wedge holder with an alternative implementation of a closing wedge according to the invention;

FIG. 22 is a diagrammatic perspective view of the closing wedge holder according to FIG. 21 with the closing wedge extended; and

FIG. 23 is a diagrammatic view of a detail of the closing wedge holder according to FIG. 22 in the state coupled with a holding jaw in accordance with the invention.

### DETAILED DESCRIPTION OF THE INVENTION

Referring now to the figures of the drawings in detail and first, particularly, to FIGS. 1 to 4 thereof, there is shown a coupling device 100 with a first and second coupling element 10 and 20 as an exemplary embodiment both in representations showing the two coupling elements 10 and 20 in the separated state and in the connected state.

FIG. 1 shows the first coupling element 10 with a cuboid closing wedge holder 13, on each of the longitudinal sides of which a closing wedge 11 and 12 is mounted so as to be displaceable in the z direction. The closing wedges 11 and 12 are in each case realized on their free end faces 11a and 12a with a symmetrical wedge-shaped cross section thereby forming in each case two wedge faces 11b and 12b.

According to FIG. 1, the closing wedge holder 13 of the first coupling element 10 is disposed on a panel 17 which forms the end face of a vehicle door 3 of a vehicle body 1. A motorized driving device 30 and an operative connecting device 40, which produces an operative connection between the closing wedges 11 and 12 and the driving device, are disposed on the other side of the panel 17, i.e. inside the vehicle door 3.

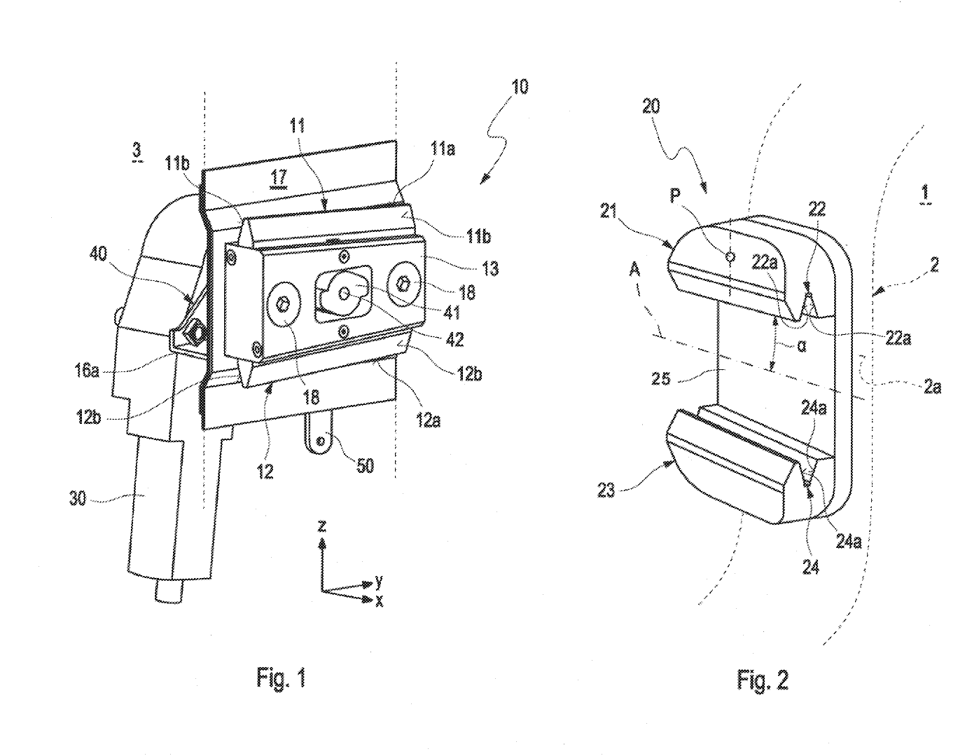

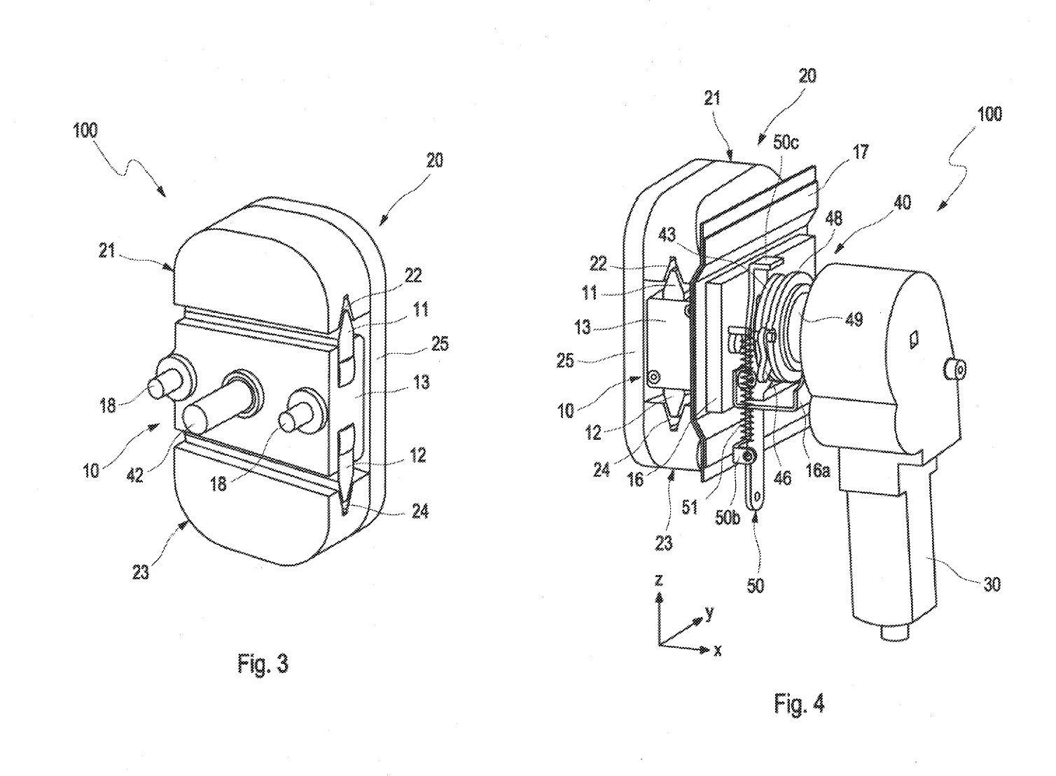

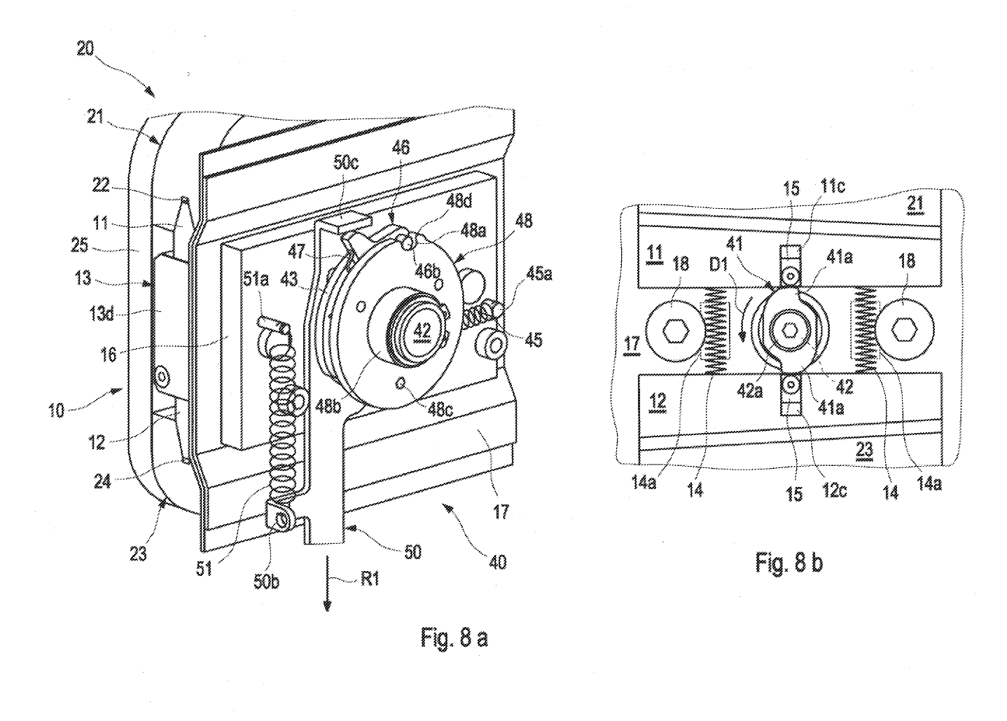

The second coupling element 20 according to FIG. 2 includes two holding jaws 21 and 23, which are disposed spaced apart from one another on a base plate 25 and between them receive the closing wedge holder 13 with the two closing wedges 11 and 12, as is shown in FIG. 3. This second coupling element 20 is mounted on a B pillar 2 of the vehicle body 1, which is indicated schematically in FIG. 2, such that as a result of the vehicle door 3 closing, the dosing wedge holder 13 with the two closing wedges 11 and 12 passes between the two holding jaws 21 and 23 according to FIG. 3 and is able to be locked or coupled there with the second coupling element 20. To this end, the two holding jaws 21 and 23 in each case include a keyway 22 or 24 with wedge faces 22a or 24a, into which, for coupling and locking the two coupling elements 10 and 20, the closing wedges 11 and 12 are pressed through the use of the locking device 30, as is shown, for example, in FIG. 8a. FIGS. 3 and 4, in contrast, show the first and second coupling element 10 and 20 in a decoupled state.

In order to make it easier to insert the closing wedge holder 13 with the two closing wedges 11 and 12 between the two holding jaws 21 and 23, the two holding jaws 21 and 23 are pivoted at a point P by an angle α (for example 3°) in relation to a horizontal center line A such that the two keyways 22 and 24 taper conically toward one another (cf. FIG. 2). The side edges 11a and 12a of the two closing wedges 11 and 12 are also adapted to the conical development or profile of the two keyways 22 and 24.

In order to displace the closing wedges 11 and 12, for coupling the two coupling elements 10 and 20, out of their position decoupled with the holding jaws 21 and 23 according to FIGS. 3 and 4 into a position tensioned with the keyways 22 and 23 thereof, the operative connecting device 40, for producing an operative connection between the closing wedges 11 and 12 and the driving device 30, includes a cam disk 41, which is mounted in the closing wedge holder 13 through the use of a cam shaft 42, with two diametrically opposed cam lugs 41a, as can be seen in particular from FIG. 1. In the representation shown in FIG. 1, the cam disk 41 is situated in a position in which a straight line, formed by the two cam lugs 41a, is directed parallel to the longitudinal direction of the two closing wedges 11 and 12, that is in the y direction, which is designated below as a 0° position.

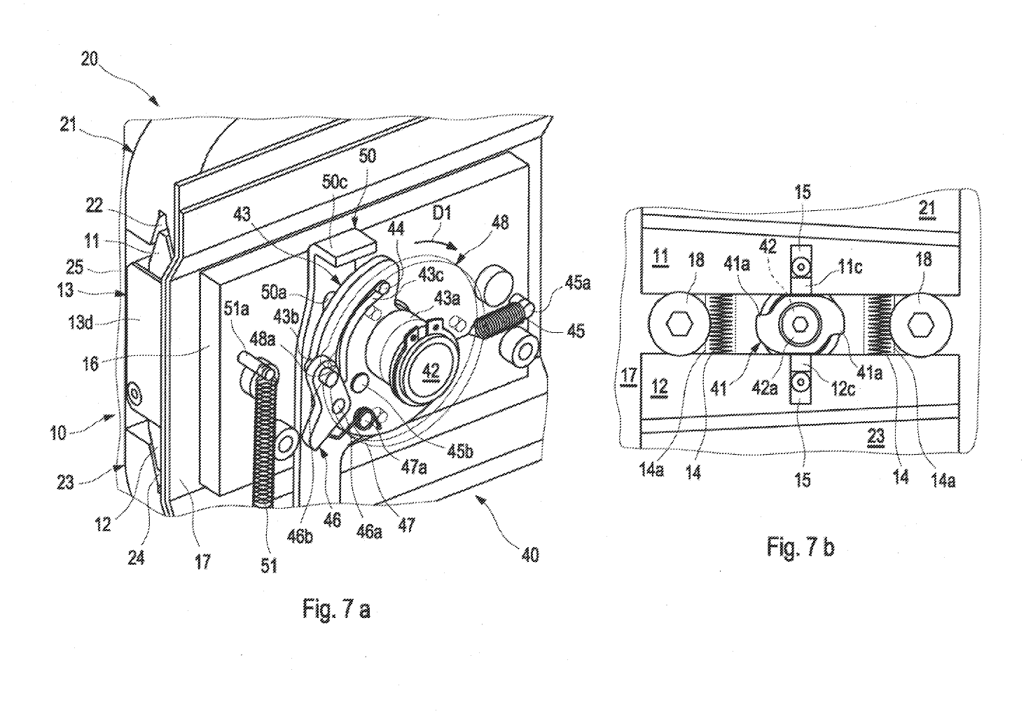

As a result of a rotation of the cam disk 41 about 90°, brought about by the driving device 30 and designated as a 90° position, the cam lugs 41a come into contact with the two closing wedges 11 and 12 and press the closing wedges apart from one another against the spring force of two return spring elements 14, which connects the two dosing wedges 11 and 12 together according to FIG. 7b or 8b, such that at the same time they are tensioned in the keyways 22 and 24 of the holding jaws 21 and 23. As a result of the two return spring elements 14, the two dosing wedges 11 and 12 are pretensioned in the direction toward one another such that as a result of a rotation of the cam disk 41 back into its starting position according to FIG. 1 or FIG. 7b, the two dosing wedges 11 and 12 are pulled out of their position tensioned by way of the keyways 22 and 24 into their decoupled position. The locking and releasing operation will be explained in detail further below.

As a result of tensioning the closing wedges 11 and 12 by way of the keyways 22 and 24, a form-locking is produced between the two coupling elements 10 and 20 in the x and z direction and on account of the conical profile of the two keyways 22 and 24 also in the y direction, namely in the direction of the vehicle interior. There is high degree of force-locking in the opposite y direction, that is toward the outside.

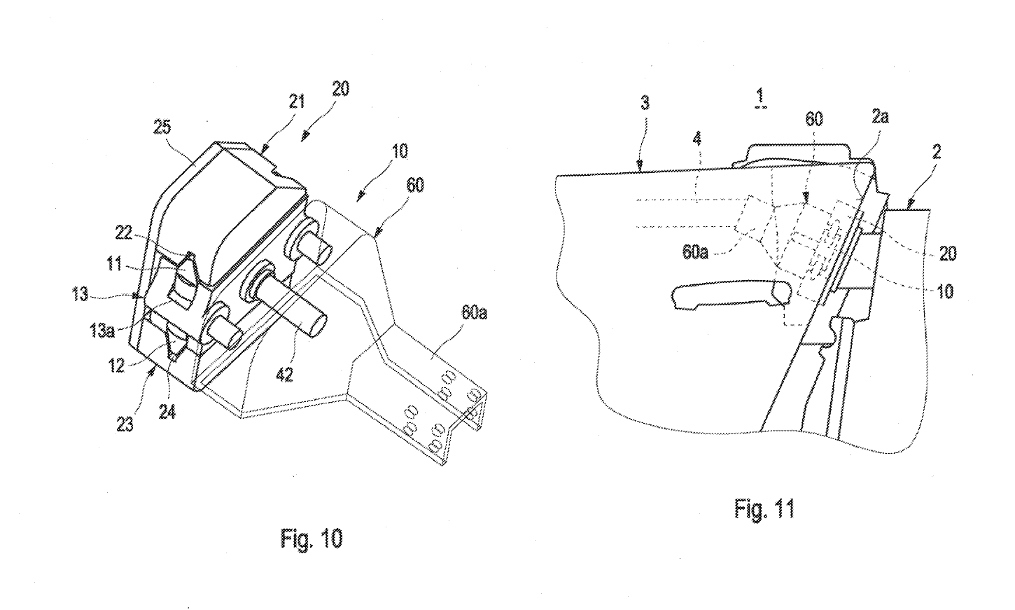

Consequently, this form-locking can be utilized for the purpose of introducing forces from the B pillar 2 into the vehicle door 3 when a corresponding door load path is constructed. To this end, according to FIG. 10, the operative connecting device 40 can be accommodated in a housing 60 which includes a load attaching portion 60a.

According to FIG. 11, the second coupling element 20 is mounted on a mounting face 2a of the B pillar 2 of the vehicle body 1, whilst the first coupling element 10 together with the housing 60 is situated at a corresponding position in the vehicle door 3, the load attaching portion 60a of the housing being connected to a reinforcing element 4 of the vehicle door 3 for forming a door load path. A usual vehicle lock can be provided below the coupled coupling elements 10 and 20.

FIG. 20 shows an alternative embodiment of the second coupling element 20 which is attached to a B pillar 2 of a vehicle body. In order to prevent ingress of dirt into the second coupling element 20, the two holding jaws 21 and 23 are bridged by a drivable or displaceable cover 26 such that the cover is able to be displaced from an open position, as shown in FIG. 20, into a closed position.

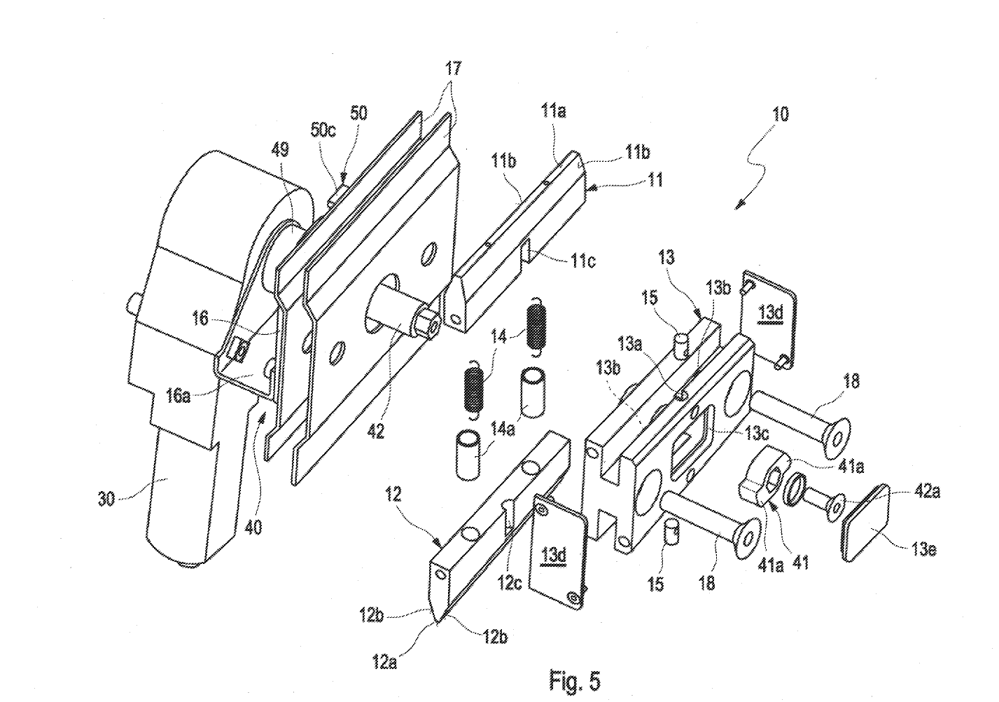

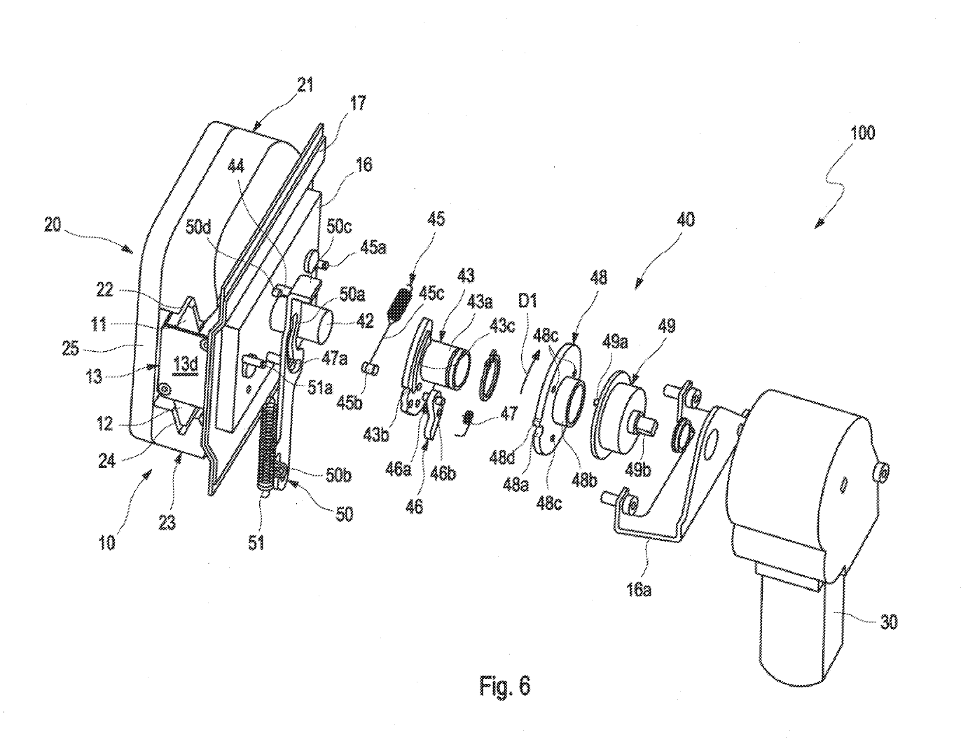

The detailed configuration of the coupling device 100 according to the invention will be described below by way of FIGS. 5 and 6.

According to FIG. 5, the closing wedge holder 13 is realized in a cuboid manner with an H-shaped cross section such that in each case a closing wedge 11 or 12 is able to be accommodated between the H legs. The closing wedges 11 and 12 are realized in a plate-like manner and include—as already described above—two wedge faces 11b and 12b in each case on their longitudinal edges 11a and 12a. To guide the closing wedges 11 and 12 in the wedge closing holder 13, semicircular grooves 13a, which in each case correspond with one another, are provided on the closing wedge holder 13 and semicircular grooves 11c or 12c on the closing wedge 11 or 12 such that the hollow cylinders formed as a result can in each case receive a closing wedge guiding element 15 (cf. FIG. 7b or 8b).

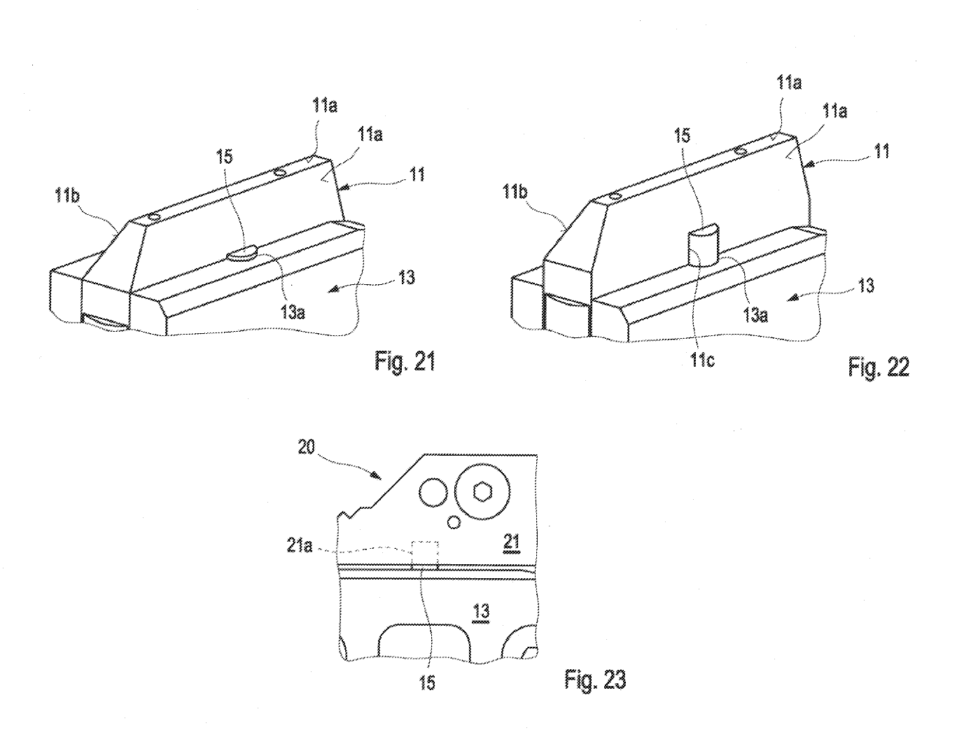

According to FIG. 21, the semicircular groove 11 c of the closing wedge 11 and the length of the closing wedge guiding element 15 are adapted to one another such that in the state inserted into the closing wedge holder 13, the upper end face of the closing wedge guiding element 15 lines up with the closing wedge holder 13 at the end face. When the closing wedge 11 is moved out of or the closing wedge 11 is moved into the key way 22 of the holding jaw 21, corresponding to the representation in FIG. 22 the closing wedge guiding element 15 also moves out of or into a semicircular groove 21a of the holding jaw 21 of the second coupling element 20 that is adapted to the closing edge guiding element 15 (cf. FIG. 23).

As a result, a form-locking is achieved between the two coupling elements 10 and 20 also in the y direction with reference to the vehicle coordinate system. Such an embodiment as shown in FIGS. 21 to 23 can also be provided for the opposite closing wedge 12 and the associated holding jaw 23.

Openings 13b are provided in the cross leg of the H shape of the closing wedge holder 13, through which openings the two return spring elements 14 connecting the dosing wedges 11 and 12 are guided. In each case elastic and sleeve-shaped closing wedge dampers 14a are sheathed over the return spring elements 14 in order to ensure that the dosing wedges 11 and 12 move gently into the keyways 22 and 24.

For accommodating the cam disk 41 which is disposed on the end of the cam shaft 42, the dosing wedge holder 13 includes a central bore 13c. The cam disk 41 is placed onto a profiled end of the cam shaft 42 and secured through the use of a fastening screw 42a.

Finally, the end faces of the closing wedge holder 13 are covered in each case with an end cap 13d.

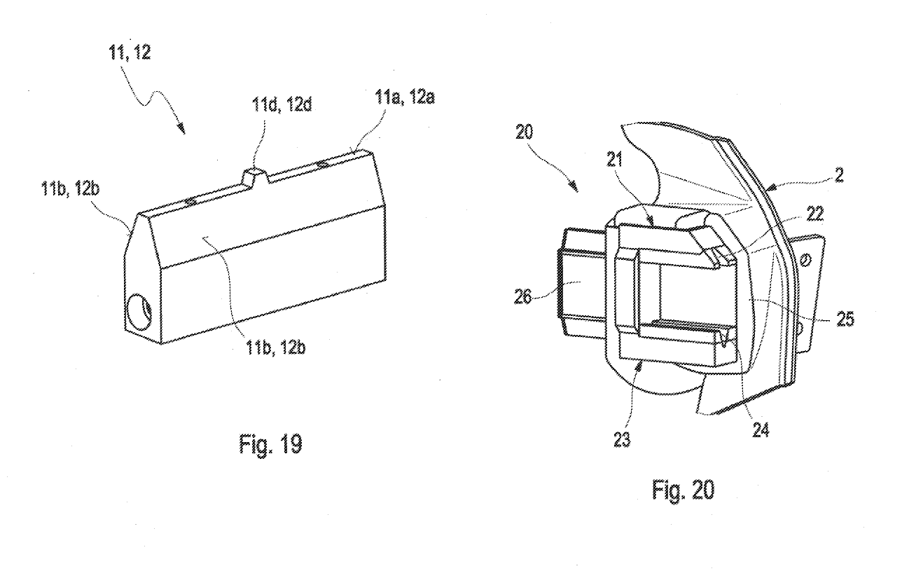

In addition, one of the two closing wedges 11 and 12 can be realized with a closing lug 11d or 12d, as is shown in FIG. 19. Accordingly, the closing lug stands perpendicularly in the middle of the side edge 11a or 12a and consequently extends in the z direction with reference to the reference system on the vehicle side. This results in form-locking being effected between the two coupling elements 10 and 20 in the y direction both in the direction of the vehicle interior and in the direction toward the outside. Both closing wedges 11 and 12 can also be realized with such a closing lug 11d and 12d.

The axial configuration along the cam shaft 42, formed of the closing wedge holder 13, the panel 17 and a base plate 16 is held together by two mounting screws 18.

Proceeding from the base plate 16 as far as up to the driving device 30, FIG. 6 shows an explosion-like representation of the operative connecting device 40 for producing the operative connection between the driving device 30 and the closing wedges 11 and 12.

The cam disk 41 which sits on the end of the cam shaft 42 has already been described. The other end of the cam shaft 42 projects through the base plate 16 and carries a control disk 43, which is connected non-rotatably, i.e fixed against relative rotation, to the cam shaft 42 and on the flange 43a of which a driving disk 48 is rotatably mounted. The control disk 43 and the driving disk 48 are releasably connected through the use of an entrainment device 46, which is disposed so as to be pivotable on the control disk 43 and is realized as an angle lever. The entrainment device 46 is mounted through the use of a rotational axis 46a on the control disk 43 in such a manner that a pin-shaped locking bar 46b, which is disposed on the end of a leg, is pressed both into a latching device 48a of the driving disk 48 and into a latching device 43b of the control disk 43 under the spring force of a spring element 47 which is realized as a leg spring.

As a result of a rotation of the driving disk 48 initiated by the driving device 30, a corresponding rotation of the control disk 43 is effected, the rotation thereof being limited by a stop device 44, which is realized as a stop pin and interacts with an arcuate control slot 43c of the control disk 43, substantially to a 90° angular range.

A spring element 45, which is realized as a tension spring and is pivotally mounted on the control disk 43 at one end through the use of a fixing pin 45a by way of the base plate 16 and at the other end through the use of a return cable 45c through the use of a connecting pin 45b, is additionally provided. A rotation into the rotational direction D1 brings about a pretensioning of the control disk 43 into the opposite rotational direction.

A non-rotatable coupling between the driving disk 48 and the driving device 30 is achieved by a coupling disk 49 which on one side sits on a flange 48b of the driving disk 48 and is non-rotatably connected to the driving disk 48 through the use of driving pins 49a that engage in driving bores 48c of the driving disk 48 and on the other side produces a non-rotatable coupling with the driving device 30 through the use of a connecting element 49b that is realized as a square shaft. The coupling disk 49 is mounted in a holding element 16a which is mounted onto the base plate 16.

An emergency release lever 50 which is provided for an emergency release function of the coupling device 100 abuts flatly against the base plate 16 and is mounted so as to be longitudinally displaceable through the use of the rotational axis 47a of leg spring 47 that is guided in a guide slot 50a, a limiting pin 50d being disposed additionally on the base plate 16 for longitudinal guidance.

In addition, one end of the emergency release lever 50 includes a flange 50c which is angled by approximately 90° and, when manually displaced longitudinally, moves from a rest position into operative contact with the entrainment device 46, the emergency release lever 50 being pretensioned in the direction of its rest position through the use of a spring element 51 that is realized as a return spring. At one end the return spring 51 is connected to a tab 50b on the other end of the emergency release lever 50 and at the other end it is connected to the base plate 16 through the use of a fixing pin 51a.

The customary method of operation of the coupling device 100 described up to now is to be explained below and entails that, with the vehicle door 3 dosed, that is when the dosing wedge holder 13 with the closing wedges 11 and 12 lies between the two holding wedges 21 and 24, in dependence on the vehicle speed the coupling device 100 is locked automatically through the use of the motorized driving device 30, for example an electric motor, i.e. the two closing wedges 11 and 12 are pressed into the two keyways 22 and 24 of the holding jaws 21 and 23 and the two coupling elements 10 and 20 are consequently transferred into the coupled state. An equally motorized release, that is a decoupling of the two coupling elements 10 and 20, is effected when an inside actuating lever of the coupling device 100 is actuated and, as a result, the two closing wedges 11 and 12 are pulled out of the keyways 22 and 24 by the return spring elements 14.

According to FIGS. 7a and 7b, the two closing wedges 11 and 12 are situated in their decoupled state, according to FIG. 7a therefore they are not tensioned by way of the wedge faces 22a and 24a of the keyways 22 and 24 through the use of their wedge faces 11b and 12b. In this case, the cam disk 41 is situated in the position shown in FIG. 7b and designated as the 0° position which corresponds to a first position of the control disk 43.

The first position of the control disk 43, which corresponds to the decoupled state of the two coupling elements 10 and 20, is defined by the stop pin 44 abutting against one end of the arcuate control slot 43c. In addition, in the first position of the control disk 43, the control disk is non-rotatably coupled with the driving disk 48 through the use of the entrainment device 46, the entrainment device 46 being pretensioned by the leg spring 47 in such a manner that the locking bar 46b is pressed both into the latching device 48a of the driving disk 48 and into the latching device 43b of the control disk 43. The control disk 43 is pretensioned in opposition to the direction of rotation D1 through the use of the tension spring 45.

To lock the coupling device 100, the electric motor 30 is controlled such that the driving disk 48 moves in the direction of rotation D1, as a result of which the control disk 43, and as a result also the cam disk 41, is entrained in the same direction of rotation D1, that is in the direction of the 90° position. After rotating by approximately 90°, the stop pin 44 strikes against the other end of the control slot 43c, whereupon the control disk 43 has reached a second position in which the closing wedges 11 and 12 are pressed by the cam lugs 41a of the cam disk 41 into the keyways 22 and 24 of the two closing jaws 21 and 23. As a result of the non-rotatable coupling between the control disk 43 and the driving disk 48, the driving disk 48 is no longer able to rotate either such that on account of the rising motor current of the electric motor 30 that is realized as the driving device, it is switched off. On account of the self-locking of the electric motor 30, the tensioned tension spring 45 is not able to rotate the control disk 43 back into its first position. This situation is shown in FIGS. 8a and 8b, In the locked state of the coupling device 100, the electric motor 30 remains switched off; consequently, in the locked state no electric power is consumed by the coupling device 100.

If the electric motor 30 receives a signal to release the coupling device 100, the coupling device is actuated in such a manner that the driving disk 48 is moved in opposition to the direction of rotation D1 such that on account of the coupling with the control disk 43, it is moved out of its second position into its first position according to FIG. 7a, until, on account of the movement of the control disk 43 that is limited by the stop pin 44, the rising motor current of the electric motor 30 results in its shutdown. When the first position of the control disk 43 is reached, the cam disk 41 has also rotated back into the 0° position according to FIG. 7a such that, as a result, the dosing wedges 11 and 12 are pulled back out of the keyways 22 and 24 on account of the return spring elements 14. The two coupling elements 10 and 20 are consequently decoupled again.

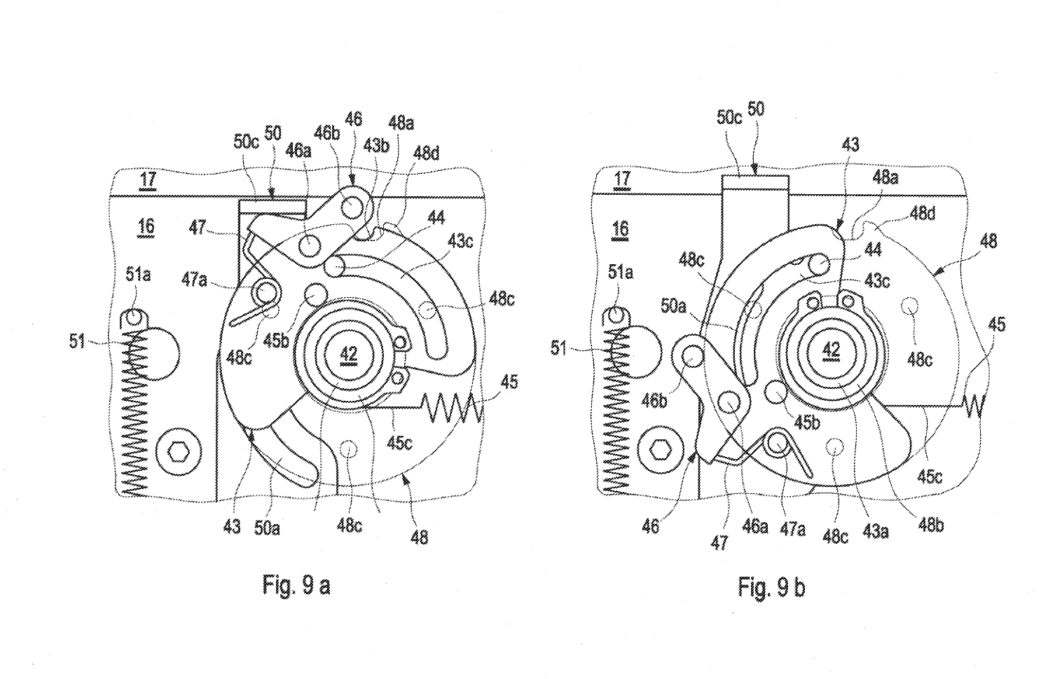

If the motorized driving device 30 fails in the locked state of the coupling device 100, the emergency release lever 50, which is connected to an inside actuating lever or a door handle of a usual vehicle door lock, serves for emergency release, as is explained below by way of FIGS. 9a and 9b.

Proceeding from the coupled state of the two coupling elements 10 and 20 according to FIGS. 8a and 8b where the control disk 43 is situated in its second position, the emergency release lever 50 is displaced in the direction R1 by a door handle of the vehicle door 3 being actuated such that, as a result, the angled flange 50c is pressed against the entrainment device 46 which, as a result, is pivoted with the driving disk 48 out of its rest position against the spring force of the leg spring 47 and at the same time the control disk 43 is decoupled from the driving disk 48 corresponding to the representation according to FIG. 9a. The control disk 43 is rotated even further by the flange 50c until the locking bar 46b of the entrainment device 46 is released securely from both the latching device 48a of the driving disk 48 and from the latching device 43a of the control disk 43 corresponding to the representation according to FIG. 9a.

The emergency release lever 50 is displaced back into its rest position by the return spring 51 and the spring force of the pretensioned tension spring 45 takes over the further rotating of the control disk 43 into its first position in which the stop pin 44 terminates the rotation at the end of the control slot 43c (cf. FIG. 9b). During the rotation into the first position, the locking bar 46b slides along the circumference of the driving disk 48 and at the same time the cam disk 41 is rotated back out of the 90° position into its 0° position in order to make it possible for the closing wedges 11 and 12 to be pulled back out of the keyways 22 and 24 of the holding jaws 21 and 23. The driving disk 48, in contrast, stops in its position for the duration of the entire emergency release operation on account of the self-locking of the electric motor 30.

Once the fault in the electric motor 30 has been eliminated, the coupling device 100 is locked in a motorized manner by the driving disk 48 being driven in the direction of rotation D1 by the electric motor 30 until the latching device 48a moves under the locking bar 46b such that the locking bar is able to latch into both the latching device 48a of the driving disk 48 and the latching device 43b of the control disk 43. The control disk 43 is consequently coupled with the driving disk 48 again and can once again be entrained into the second position by the driving disk for locking.

In order to ensure the locking bar 46b latches securely into the latching device 48a of the driving disk 48, the latching device 48a initially merges in the direction of rotation D1 into a lifting lug 48d which projects on the circumferential face of the driving disk 48 such that, as a result, the locking bar 46b is pivoted against the spring force of the leg spring 47 prior to latching into the latching device 48a.

All the components of the first coupling element 10 which exert a control function or actuating function, that is such as the closing wedges 11 and 12, the control disk 43, the entrainment device 46 and the emergency release lever 50, are pretensioned through the use of spring elements in the direction of their rest position which corresponds to the decoupled state of the coupling device 100 and consequently improves its operational reliability.

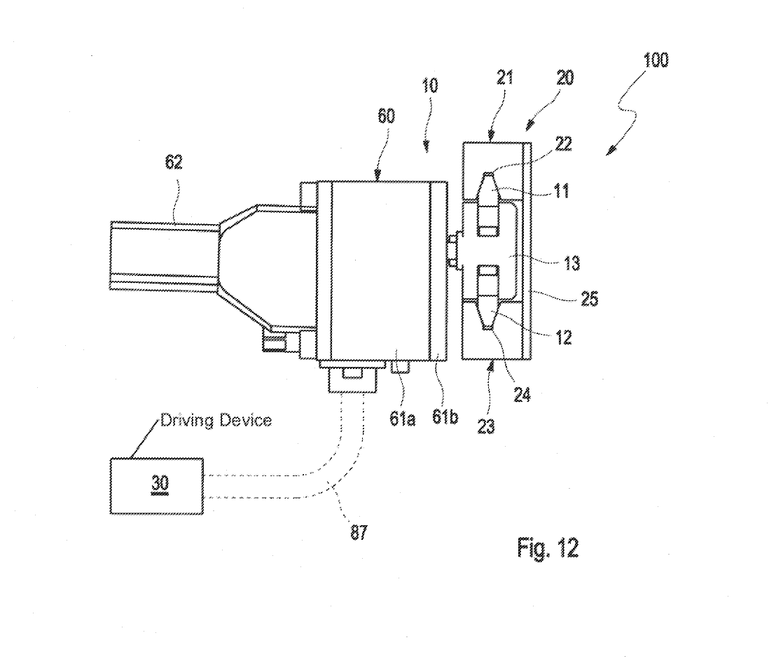

FIGS. 12 to 18 show a further exemplary embodiment of the coupling device 100 according to the invention, a side view of which is shown according to FIG. 12. The coupling device 100 accordingly includes a first coupling element 10 with a closing wedge holder 13 for accommodating closing wedges 11 and 12 as well as a housing 60 for accommodating the operative connecting device 40 for producing an operative connection between the closing wedges 11 and 12 and a motorized driving device 30. The configuration of the closing wedge holder 13 and of the holding jaws 21 and 23 of the second coupling element 20 correspond to that of the above-described coupling device 100 according to FIGS. 1 to 11 or to the alternative embodiments according to FIGS. 19 to 23.

FIG. 12 shows the coupling device 100 with the two coupling elements 10 and 20 in the coupled state, where the two closing wedges 11 and 12 are tensioned through the use of their wedge faces 11b and 12b with the wedge faces 22a and 24a of the keyways 22 and 24 of the holding jaws 21 and 23, this being effected by the motorized driving device 30 through the use of a flexible shaft 87 which is connected to the housing 60.

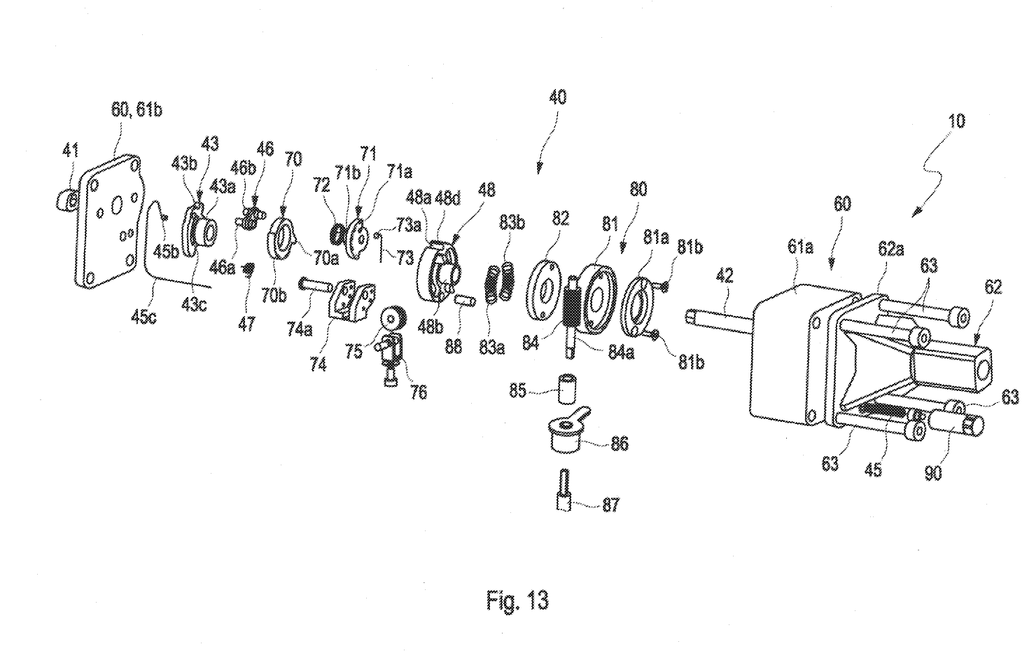

According to FIG. 12 and FIG. 13, the housing 60 is formed of a housing pot 61a with an associated cover 61b, a load attaching element 62 being screw-connected to the rear side of the cover through the use of a base plate 62a on the bottom part of the housing part 61 according to FIG. 12. Consequently, the coupling device 100 according to FIG. 11 can also be used for coupling a vehicle door with a B pillar such that force is able be transmitted out of the vehicle body into the vehicle door via the coupling when the load attaching element 62 of the first coupling element 10 is connected to a reinforcing element of the vehicle door.

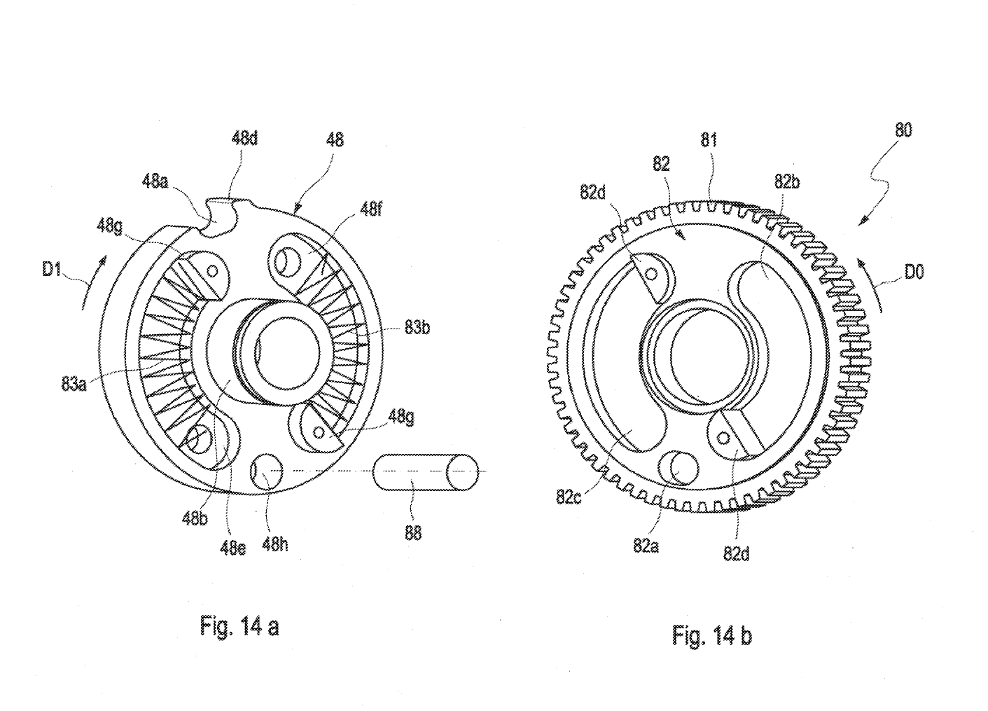

FIG. 13 shows an exploded representation of the operative connecting device 40 which is received by the housing 60 of the first coupling element 10 according to FIG. 12, the exploded representation is described below together with FIG. 14 and FIGS. 15 to 17 which show a functioning first coupling element 10.

The operative connecting device 40 includes components which are identical or extensively identical to those of the operative connecting device 40 of the above-described coupling device 100 (cf. FIGS. 1 to 10), consequently they are only referred to below.

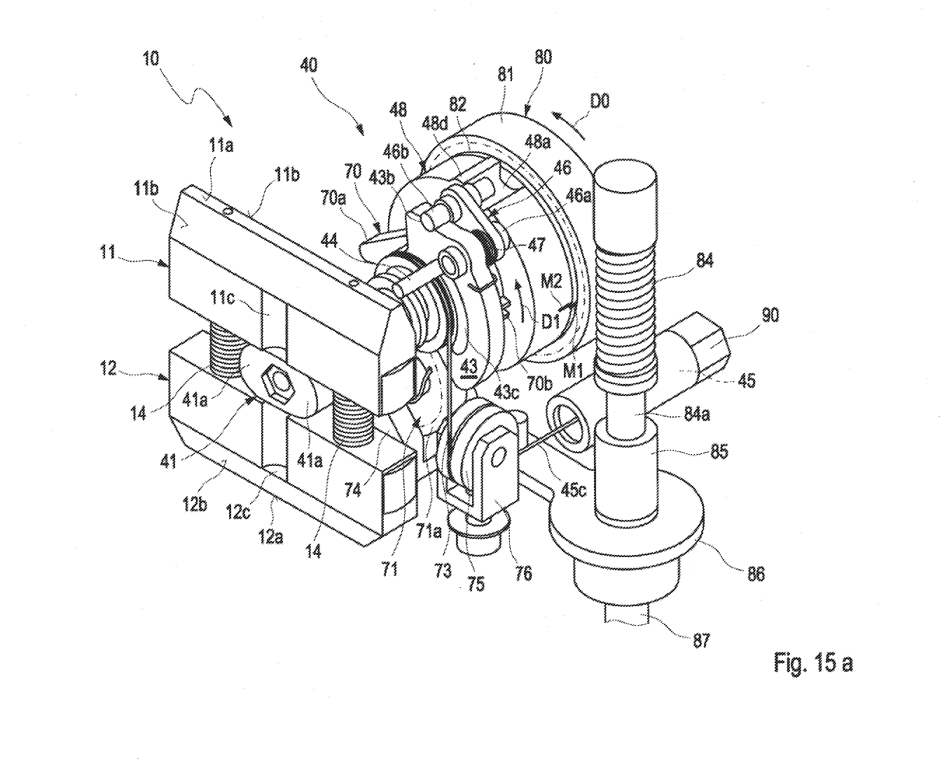

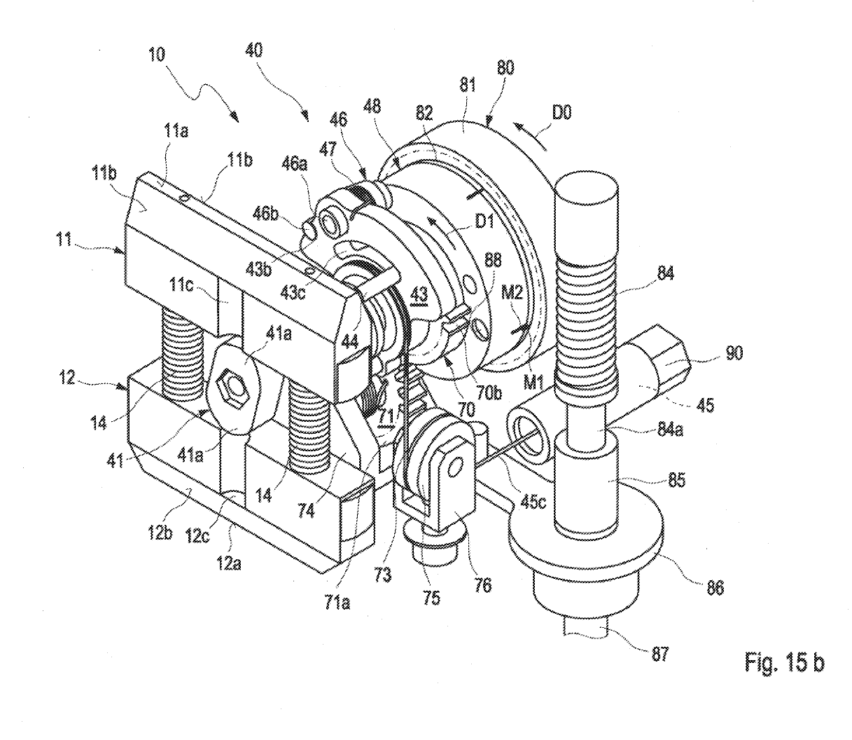

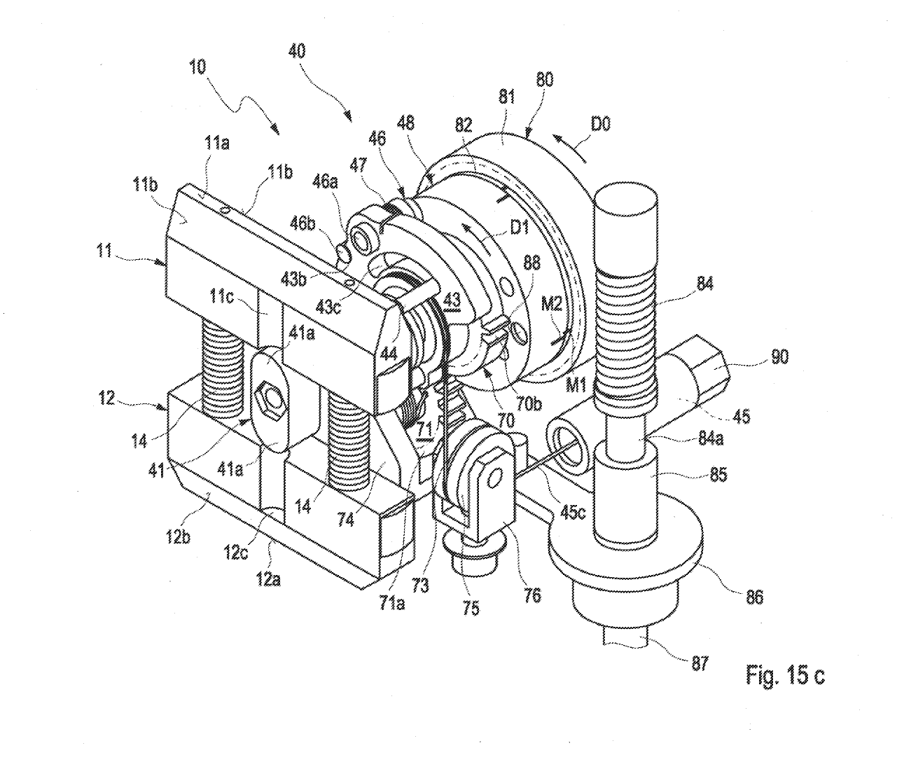

Thus, according to FIG. 13, the closing wedges 11 and 12 are moved or driven into the keyways 22 and 24 of the holding jaws 21 and 23 also by way of a cam disk 41 that is disposed at the end of a cam shaft 42 as a result of a rotation that is initiated by the driving 30 device out of a 0° position corresponding to FIG. 15a into a position substantially 90° hereto according to FIG. 15b or FIG. 15c.

The cam disk 41 according to FIGS. 13 and 15 is realized as a symmetrical two-sided lever with semicircular ends as cam lugs 41a.

The rotation of the cam disk 41, which is non-rotatably connected to the cam shaft 42, is brought about by a control disk 43, which is also connected non-rotatably to the cam shaft 42 and includes substantially the same geometry as that from the above-described exemplary embodiment and also fulfills the same function. Just as already described above in conjunction with the first exemplary embodiment, the control disk 43 is connected through the use of an entrainment device 46 in a releasable manner to a driving disk 48 which, in turn, produces a rotation with a worm gear that is driven by the driving device 30, formed of an entrainment disk 80 that includes a worm wheel 81 and a worm 84.

The coupling of the control disk 43 with the driving disk 48 is effected through the use of the entrainment device 46 which is realized as a one-sided lever which is pivotably mounted on the control disk 43 through the use of the rotational axis 46a and is pressed by a leg spring 47 into a position in which a locking bar 46b, which is disposed on the other end, engages at the same time in a latching device 43b of the control disk 43 and a latching device 48a of the driving disk 48. FIG. 15a shows the first coupling element 10 in the decoupled state where the control disk 43 is situated in its first position and the two dosing wedges 11 and 12 are moved out of the keyways 22 and 24 of the second coupling element 20 which corresponds to the 0° position of the cam disk 41.

The cam disk 43 is connected to a tension spring 45 through the use of a return cable 45c, the return cable 45c being connected at one end to the control disk 43 through the use of a connecting pin 45b and at the other end to the tension spring 45 which is disposed in a spring dome 90. As can be seen in FIG. 15a, the return cable 45c is guided from the direction of the spring dome 90, which is aligned perpendicular to the plane of rotation of the control disk 43, through the use of a guide roper 75, which is mounted in a bearing block 76, into this plane of rotation. As a result of a rotation of the control disk 43 in the direction of rotation D1, the tension spring 45 is tensioned such that, as a result, a return force engages at the control disk 43 in opposition to the direction of rotation D1 and it is rotated back into its first position when the coupling with the driving disk 48 is released.

As a result of the releasable coupling, realized by the entrainment device 46, between the control disk 43 and the driving disk 48, in the case of an initiated rotation of the same in the direction of rotation D1, the control disk 43 is entrained out of its first position, in which the cam disk 41 is situated in the 0° position, in the direction of is second position, whilst the cam disk 41 is rotated in the direction of its 90° position and at the same time the two closing wedges 11 and 12 are pressed apart from one another into the keyways 22 and 24 of the holding jaws 21 and 23.

The driving disk 48 is driven through the use of the worm gear already described, formed of the entrainment disk 80 with worm wheel 81 and the worm 84. The worm 84 is provided non-rotatably on a worm axle 84a and is connected through the use of a coupling 85 to the flexible shaft 87 which is guided to the driving device 30. A mounting bracket 86 serves for fixing the arrangement.

The entrainment disk 80 is formed of a worm wheel 81, which engages with the worm 84, and a spring attaching wheel 82, which produces a spring coupling between the driving wheel 48 and the worm wheel 81. A flange ring 81a holds the named parts together through the use of fastening screws 81b as entrainment disk 80. The entrainment disk 80 is rotatably mounted on a flange 48b of the driving disk 48 and is secured by a locking ring.

The spring coupling between the driving disk 48 and the spring attaching wheel 82 is explained by way of FIGS. 14a and 14b. The worm wheel 81 according to FIG. 14b includes a circumferential sprocket which, in the direction of the driving disk 48 shown in FIG. 14a, realizes a flange which receives the spring attaching wheel 82. The oppositely situated radial faces of the driving disk 48 and of the spring attaching wheel 82 include in each case two radially opposite arcuate grooves 48e and 48f or 82b and 82c such that, in pairs, they can receive a play-compensating spring 83a and 83b in each case between them. The arcuate grooves 48e and 48f or 82b and 82c include at the end in each case holding lugs 48g or 82d, on which the play-compensating springs 83a and 83b are suspended. Thus, the play-compensating spring 83a or 83b is connected at one end to the holding lug 48g of the driving disk 48 and at the other end to the holding lug 82d of the spring attaching wheel 82.

A relative rotation of the spring attaching wheel 82 in relation to the driving disk 48 as far as up to a maximum rotation angle is made possible through the use of a connecting pin 88 which, at one end is connected fixedly to the driving disk 48 through the use of a receiving bore 48h and at the other end engages into a longitudinal groove 82a on the radial face of the spring attaching wheel 82. The longitudinal groove 82a is defined in each case by a semicircular end face which is adapted to the connecting pin 88 and defines the relative rotation of the driving disk 48 and of the spring attaching wheel 82 and consequently serves as a stop for the connecting pin 88. The longitudinal groove 82a includes a length which allows, for example, a relative rotation between the driving disk 48 and the spring attaching wheel 82 of, for example, 5°.

Driving of the entrainment disk 80 in the direction of rotation D0 brings about entrainment of the driving disk 48 in the same direction D1 when the resultant spring force of the two play-compensating springs 83a and 83b exceeds the frictional forces. When the rotation of the driving disk 48 is stopped, the entrainment disk 80 continues to be rotated against the spring force of the play-compensating springs 83a and 83b until the connecting pin 88 strikes against one of the end-face stop faces of the longitudinal groove 82a of the spring attaching wheel 82.

The spring coupling is used for play compensation that occurs during the coupled state of the two coupling elements 10 and 20 between the closing wedges 11 and 12 and the keyways 22 and 24 of the closing jaws 21 and 23 that receive them, as is explained below by way of FIGS. 15a, 15b, and 15c.

As already explained, FIG. 15a shows the released state of the first coupling element 10 where the control disk 43 is situated in its first position defined by the stop pin 44. The relative position of the driving disk 48 and of the entrainment disk 80 is characterized in each case by markings M1 or M2. The two markings M1 and M2 show no misalignment.

As a result of controlling the motorized driving device 30 in a corresponding manner, rotation of the entrainment disk 80 is brought about in the direction of rotation D0 through the use of the flexible shaft 87 and the worm 84 such that the driving disk 48 is entrained and the control disk 43 which is coupled with the driving disk is rotated out of its first position in the direction of rotation D1, as can be seen in FIG. 15b. According to FIG. 15b, the rotating operation is terminated when the cam disk 41 has been rotated out of its 0° position into an approximately 85° position where the two dosing wedges 11 and 12 have already been moved completely into the keyways 22 and 24 of the second coupling element 20. The control disk 43 is situated in an intermediate position briefly just before its second position in which the stop pin 44 does not yet strike against the end of the control slot 43c of the control disk 43. The markings M1 and M2 are still aligned in the movement state of the first coupling element 10. The entrainment disk 80 is rotated further by the driving device 30 beyond this state, indicated by the offset markings M1 and M2, until the maximum possible rotation angle between the driving disk 48 and the entrainment disk 80 is achieved and at the same time the spring force of the two play-compensating springs 83a and 83b has risen to a maximum value, At the same time, further rotation is blocked, as a result of which the motor current, for example, of the driving device 30, which is realized as a self-locking electric motor, rises and results in the electric motor 30 being switched off. With the coupling device 100 in the coupled state, the electric motor 30 remains switched off; on account of the self-locking even rotation of the worm wheel 81 of the entrainment disk 80 in the direction opposite to D0 is prevented.

As a result of the relative rotation of the entrainment disk 80 in relation to the driving disk 48, a misalignment between the two markings M1 an M2 is generated, as can be seen from FIG. 15c. The driving disk 48 is consequently pretensioned in the direction of rotation D1. If, with the two coupling elements 10 and 20 in the coupled state, play then arises between the closing wedges 11 and 12 and the keyways 22 and 24, the play-compensating springs 83a and 83b press the driving disk 48 further in the direction of rotation 131, as a result of which the control disk 43 is also entrained in the same direction of rotation D1 and at the same time the cam disk 41 is rotated further in the direction of the 90° position and at the same time the closing wedges 11 and 12 compensate for this play.

For releasing the two coupling elements 10 and 20 in a motorized manner, the operation runs in the reverse direction, i.e. the driving device 30 is controlled in such a manner that the entrainment disk is moved out of the position according to FIG. 15c in a direction opposite to the direction of rotation D0 until the state according to FIG. 15a is reached again.

An emergency release function that is explained below by way of FIGS. 13, 16 and 17 serves to make releasing the two coupled coupling elements 10 and 20 possible in spite of a failed or faulty driving device. With the emergency release function, the coupling device 100 can not only be mechanically or manually released when in the already locked state, but also if the driving device 30 fails during the locking operation or release operation or a problem occurs with regard to the same and the cam disk 41 can be situated in such a case within the range of the 0° position up to the 90° position.

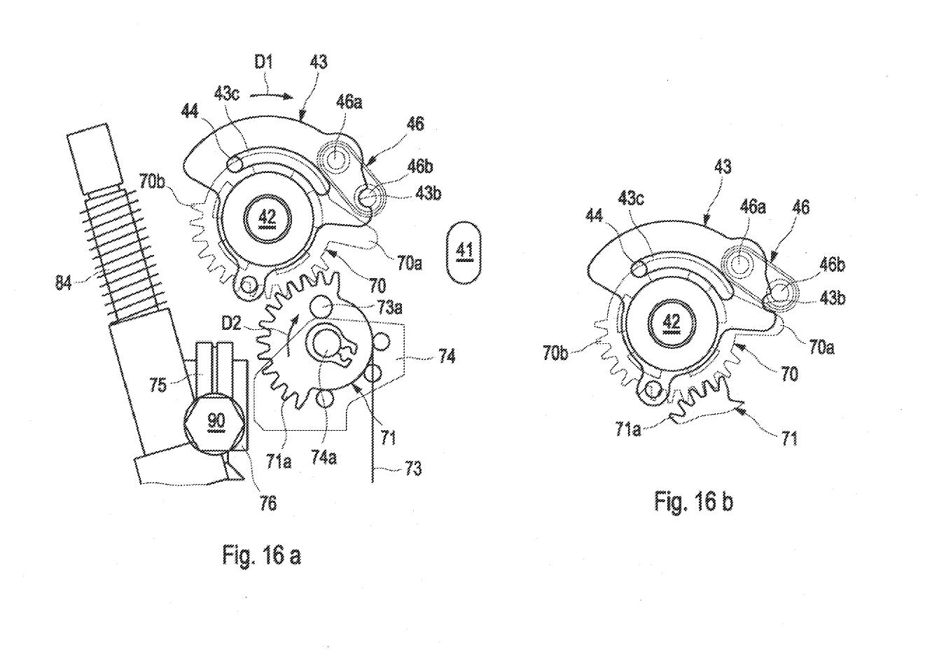

The emergency release function is realized through the use of a release ring 70, which is rotatably mounted on a flange 46a of the control disk 46 and can be moved with the entrainment device 46 into an operative connection, and a toothed segment wheel 71, which is mounted through the use of a rotational axis 74a in a bearing block 74 and, according to FIG. 16a, produces a rotary connection to a toothed segment 70b of the release ring 70 through the use of a toothed segment 71a.

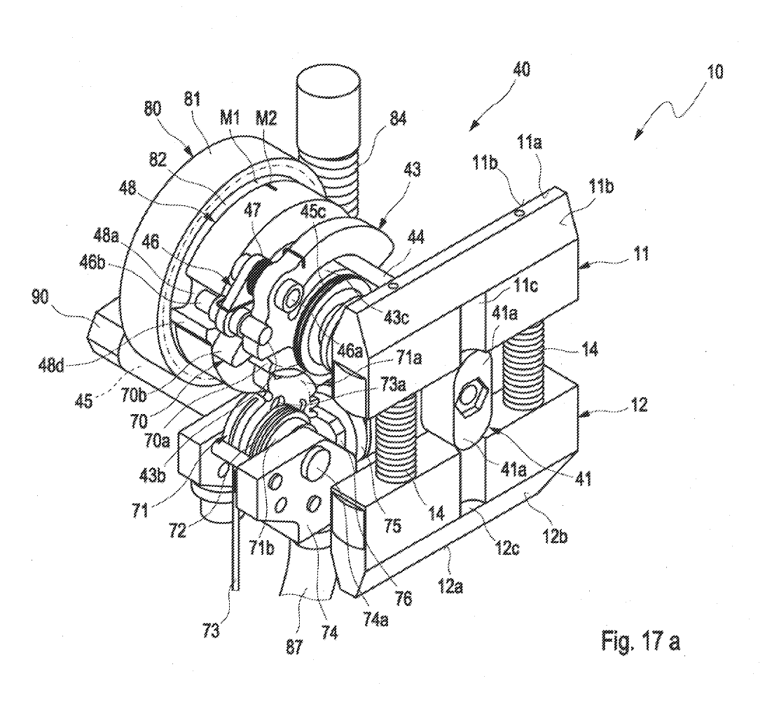

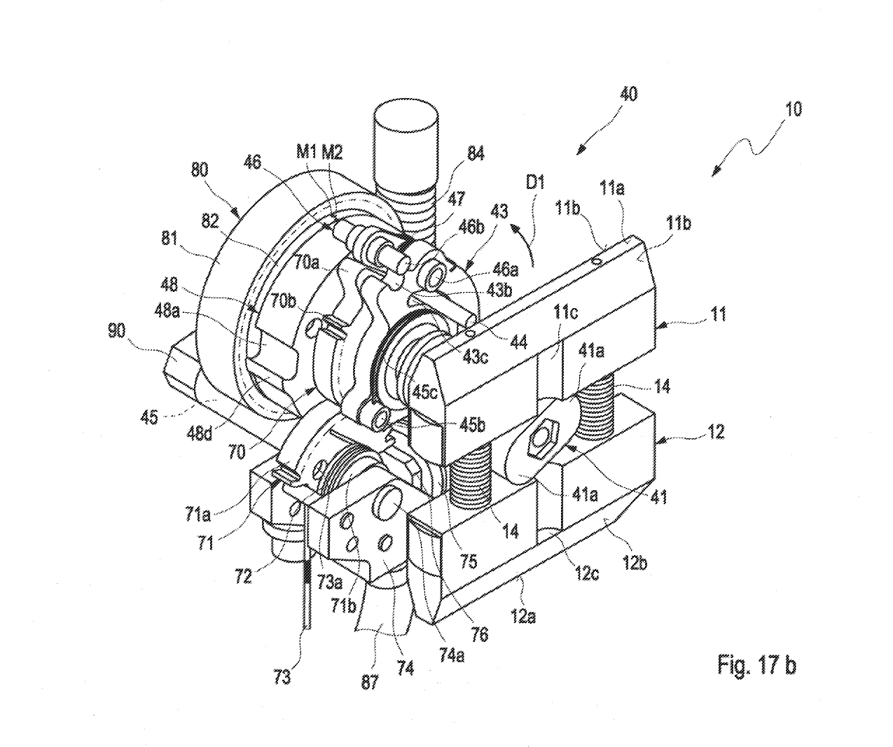

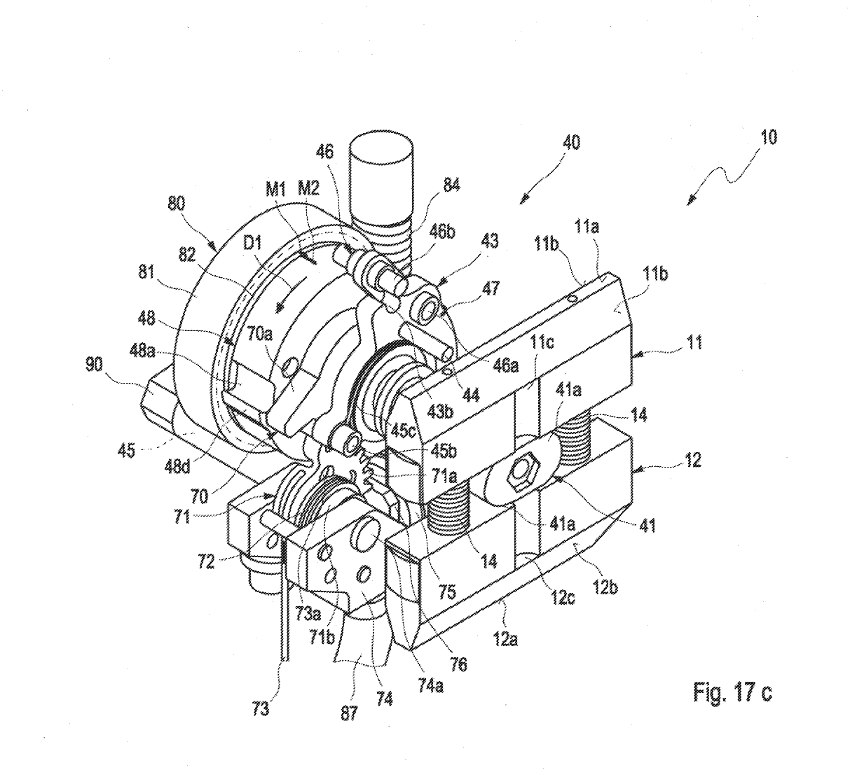

The release ring 70 includes a control cam 70a which, when the release ring pivots out of a rest position in opposition to the direction of rotation D1, moves into contact with the entrainment device 46, the locking bar 46b of which is locked with both the latching device 43b of the control disk 43 and with the latching device 48a of the driving disk 48 (cf. FIGS. 16a and 17a).

Pivoting the release ring 70 out of its rest position is brought about through the use of the toothed segment wheel 71, which is held through the use of a leg spring 72 which is mounted on a flange 71b of the toothed segment wheel 71, in a first pivot position that corresponds to the rest position of the release ring 70. For releasing the control disk 43 from the driving disk 48, the toothed segment wheel 71 is connected through the use of a connecting pin 73a to a tension cable 73, which is guided by way of its other end on a door handle of the vehicle door, such that as a result of actuation of the door handle, the toothed segment wheel 71 is pivoted against the spring force of the angle spring 72 out of its first pivot position in the direction of rotation D2 into a second pivot position, as a result of which on account of the toothed segment transmission, the release ring 70 is pivoted in opposition to the direction of rotation D1 into an operating position and at the same time lifts the locking bar 46b out of the latching device 43b and 48b, as is shown in FIG. 16b, and then in abutment with the entrainment device 46, the control disk 43 is pivoted further in opposition to the direction of rotation D1, thereby entraining the cam disk 41 in the direction of its 0° position. It can be seen from FIG. 17b that the driving disk 48 stops in the position which corresponds to locking with both coupling elements 10 and 20. In addition, the toothed segment wheel 71 is also rotated back by the leg spring 72 into the rest position which corresponds to the release ring 71.

From this position shown in FIG. 17b of the control disk 43 released from the driving disk 48, the control disk is pulled back into its first position by the tension spring 45 that is disposed in the spring dome 90 such that the cam disk 41 has reached its 0° position corresponding to FIG. 17c.

The geometry of the control cam 70a is matched in such a manner to the geometry of the entrainment device 74 as a one-sided lever that each position of the control disk 43, in each case, represents an operating position of the release ring 70 in which, in each case, the control wheel 43 is decoupled from the driving wheel 48 through the use of the toothed segment wheel 71. Consequently, between the first position of the control disk 43, which corresponds to the decoupled state of the two coupling elements 10 and 20, and its second position, which corresponds to the coupled state of the two coupling elements 10 and 20, the control disk 43 is decoupled from the driving disk 48 through the use of the control cam 70a, even in the first position of the control disk 43 which corresponds to the 0° position of the cam disk 41.

A displaceable toothed rod which is connected mechanically to the door handle of the vehicle door can also be used in place of the toothed segment wheel 71. When the door handle is actuated, the toothed rod is displaced such that, on account of the teeth meshing with the release ring 70, the release ring is moved in opposition to the direction of rotation D1 and, as a result, the entrainment device 46 is pivoted out of the latching device 43b of the control disk 43 and out of the latching device 48a of the driving disk 48.

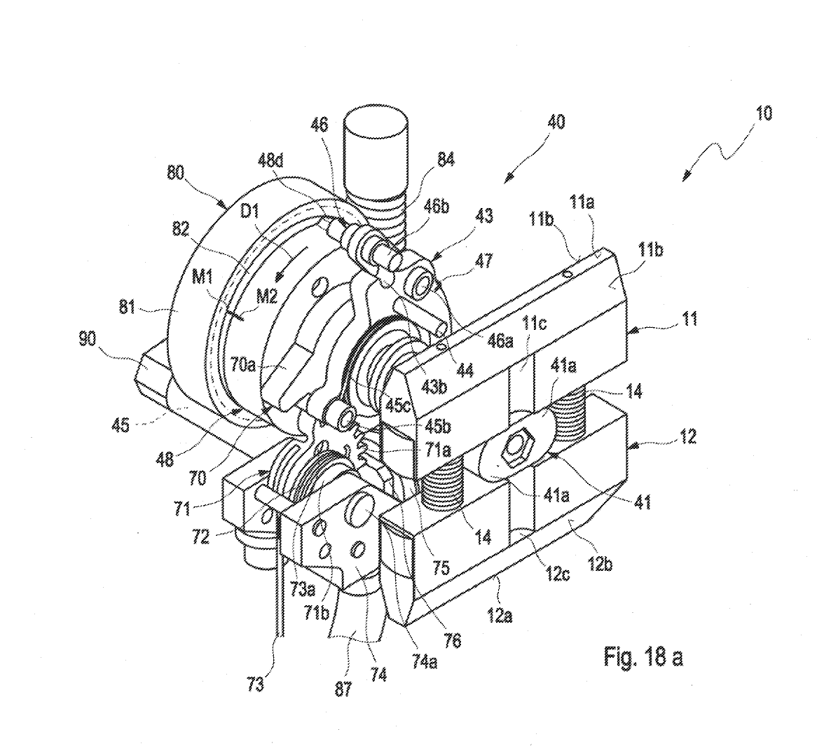

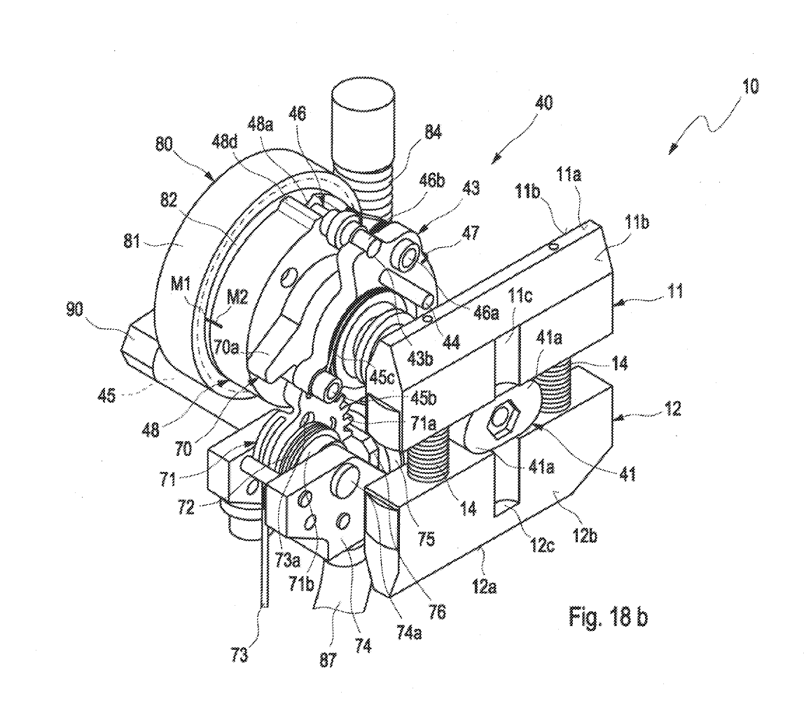

Once a fault with regard to the driving device 30 has been eliminated, motorized locking has to be carried out following a manually effected release, that is after decoupling the two coupling elements 10 and 20. The operation is explained by way of FIGS. 18a and 18b.

Proceeding from the state shown in FIG. 17c, the driving device 30 is controlled in such a manner that the driving disk 48 that is not coupled with the control disk 43 is rotated further in the direction of rotation D1 until the latching device 48a thereof moves under the locking bar 46b and, as a result, allows the locking bar to latch into the latching device 48a and 43b.

The state just before the latching device 48a runs under the locking bar 46b is shown in FIG. 18a. Before the locking bar 46b drops into the latching device 48a and 43b under the effect of the leg spring 47, the locking bar 46b is initially raised by the lifting lug 48d of the driving disk 48 against the spring force of the leg spring 47. FIG. 18b shows the state of the locking bar 46b of the entrainment device 46 latched into the latching device 48a and 43b. Consequently, the control disk 43, which is situated in the first position, is once again coupled with the driving disk 48 and can now be entrained into the second position corresponding to FIG. 17a for a new locking operation.

The coupling device 100 according to FIGS. 12 to 18 also includes the characteristic that all the components of the first coupling element 10 that exert a control function or actuating function are pretensioned through the use of spring elements in the direction of their rest position which corresponds to the released state of the coupling device 100.

### LIST OF REFERENCE CHARACTERS

1 Vehicle body

2 B pillar of the vehicle body

2a Mounting face of the B pillar 2

3 Vehicle door

4 Reinforcing element of the vehicle door 3

10 First coupling element

11 Closing wedge

11a Side edge of the dosing wedge 11

11b Wedge faces of the side edge 11a

11c Groove for dosing wedge guiding element 15

11d Closing lug of the dosing wedge 11

12 Closing wedge

12a Side edge of the dosing wedge 12

12b Wedge faces of the side edge 12a

12c Groove for dosing wedge guiding element 15

12d Closing lug of the closing wedge 12

13 Closing wedge holder

13a Groove for closing wedge guiding element 15

13b Passage openings of the closing wedge holder 13

13c Central bore of the closing wedge holder 13

13d End cap of the closing wedge holder 13

13e Covering cap of the closing wedge holder 13

14 Return spring element

14a Closing wedge damper

15 Closing wedge guiding element

16 Base plate

16a Holder element

17 Panel

18 Mounting screws

20 Second coupling element

21 Holding jaw of the second coupling element 20

21a Semicircular groove of the holding jaw 21

22 Keyway of the holding jaw 21

22a Wedge faces of the keyway 22

23 Holding jaw of the second coupling element 20

24 Keyway of the holding jaw 23

24a Wedge faces of the keyway 24

25 Base plate

26 Movable cover

30 Driving device

40 Operative connecting device

41 Cam disk

41a Cam lug

42 Cam shaft

42a Fastening screw

43 Control disk

43a Range of the control disk 43

43b Latching device of the control disk 43

43c Control slot of the control disk 43

44 Stop device, stop pin for control disk 43

45 Spring element, tension spring

45a Fixing pin of the spring element 45

45b Connecting pin of the spring element 45 with control disk 43

45c Return cable of the tension spring 45

46 Entrainment device

46a Rotational axis of the entrainment device 46

46b Locking bar of the entrainment device

47 Spring element, leg spring

47a Rotational axis of the spring element 47

48 Driving disk

48a Latching device of the driving disk 48

48b Flange of the driving disk 48

48c Entrainment bores of the driving disk 48

48d Lifting lug of the latching device 48a

48e Arcuate groove

48f Arcuate groove

48g Holding lug

48h Receiving bore for connecting pin 88

49 Coupling disk

49a Entrainment pin of the driving coupling 49

49b Square axis, connecting element of the coupling disk 49

50 Emergency release lever

50a Guiding slot of the emergency release lever 50

50b Tab of the emergency release lever 50

50c Angled flange of the emergency release lever 50

50d Limiting pin of the emergency release lever 50

51 Spring element, return spring of the emergency release lever 50

51a Fixing pin of the spring element 51

60 Housing

60a Load attaching portion of the housing 60

61a Housing pot of the housing 60

61b Housing cover of the housing 60

62 Load attaching element of the housing 60

62a Base plate of the load attaching element 62

63 Fastening screws

70 Release ring

70a Control cam of the release ring

70b Toothed segment of the release ring

71 Toothed segment element, toothed segment wheel, toothed rod

71a Toothed segment of the toothed segment wheel 71

71b Flange of the toothed segment wheel 71

72 Spring element, leg spring

73 Tension cable of the toothed segment wheel 71

73a Connecting pin of the tension cable with toothed segment wheel 71

74 Bearing block of the toothed segment wheel 71

74a Rotational axis of the toothed segment wheel 71

75 Guide roller

76 Bearing block of the guide roller 75

80 Entrainment disk

81 Worm wheel

81a Range ring

81b Fastening screws

82 Spring attaching wheel

82a Longitudinal groove for connecting pin 88

82b Arcuate groove

82c Arcuate groove

82d Holding lug

83a Play-compensating spring element

83b Play-compensating spring element

84 Worm

84a Worm axis

85 Coupling

86 Mounting bracket

87 Flexible shaft

88 Connecting pin

90 Spring dome

100 Coupling device

What is claimed is:

1. A coupling device for releasably connecting a pivotably mounted body part to a vehicle structural part, comprising:
a first coupling element and a second coupling element, said second coupling element, in a coupled state of the coupling device, being coupled in a play-free manner with said first coupling element;
said first coupling element having two locking bars, said locking bars being mounted so as to be displaceable in relation to one another in a parallel manner, said locking bars being configured as plate-shaped closing wedges;
a cuboid dosing wedge holder, said plate-shaped dosing wedges being mounted in said cuboid dosing wedge holder, said plate-shaped dosing wedges having respective wedge faces and having a respective side edge with a respective wedge-shaped cross section for forming said wedge faces;
a motorized driving device and an operative connecting device, said motorized driving device, in order to couple said first and said second coupling element, moving said locking bars apart from one another in a motorized manner by using said operative connecting device; and
said second coupling element having two holding jaws, said holding jaws receiving said first coupling element therebetween, said holding jaws having respective keyways with respective wedge faces formed therein such that said plate-shaped closing wedges are pressed, with said wedge faces of said plate-shaped closing wedges, into said keyways as a result of said plate-shaped closing wedges being displaced apart from one another in a motorized manner and thus are movable into abutment with said wedge faces of said keyways.

2. The coupling device according to claim 1, wherein:
said keyways taper conically toward one another in a longitudinal extension of said keyways thus forming a conical profile; and
said wedge faces of said closing wedges are adapted to said conical profile.

3. The coupling device according to claim 1, wherein:
each of said dosing wedges has a side edge facing a respective one of said holding jaws; and
at least one of said dosing wedges has a dosing lug on said side edge.

4. The coupling device according to claim 1, wherein said first coupling element has at least one return spring element, said at least one return spring element connects said closing wedges to one another and pretensions said closing wedges in a direction toward one another.

5. The coupling device according to claim 1, wherein:
said operative connecting device for establishing an operative connection between said motorized driving device and said closing wedges of said first coupling element includes a cam disk with two diametrically opposed cam lugs; and
said cam disk is mounted in said first coupling element such that, as a result of a rotation with said cam lugs and said closing wedges in operative connection, said closing wedges are pressed into said keyways of said holding jaws.

6. The coupling device according to claim 5, wherein:
said operative connecting device includes a control disk, said control disk is connected to said cam disk in a manner fixed against rotation relative thereto; and
a stop device limits a rotation of said control disk such that said control disk is rotatable between a first position and a second position, wherein the first position decouples said first and said second coupling element and wherein the second position couples said first and said second coupling element.

7. The coupling device according to claim 6, including:
an entrainment device;
said operative connecting device having a driving disk, said driving disk being connectable to said control disk in a manner fixed against relative rotation through use of said entrainment device;
said entrainment device being disposed in a pivotable and spring-loaded manner on said control disk such that said entrainment device establishes a releasable latching connection to said driving disk such that the latching connection is fixed against relative rotation; and
said control disk being pivotable between the first and the second position as a result of a rotation of said driving disk, wherein the rotation is brought about by said motorized driving device.

8. The coupling device according to claim 7, including:
an emergency lever provided for an emergency release of said first and said second coupling element when coupled, wherein said emergency lever, when operatively connected to said entrainment device, is displaceable such that the latching connection in the second position of the control disk to said driving disk is released; and
a spring element provided for pretensioning said control disk in a direction of the first position, said spring element pivoting said control disk into the first position when said entrainment device is unlatched.

9. The coupling device according to claim 7, including:
a release ring provided for the emergency release of said first and said second coupling element, said release ring being disposed axially with respect to said control disk, said release ring having a control cam which can be brought into operative connection with said entrainment device for releasing the latching connection of said entrainment device with said driving disk; and
an actuating device configured to effect a rotation of said release ring out of a rest position into at least one operating position such that by way of the rotation initially the latching connection, at least in the second position of the control disk, with said driving disk is released and said control disk is then rotated, through use of said entrainment device, in a direction of the first position of said control disk.

10. The coupling device according to claim 9, wherein:
said release ring has a toothed segment;
a toothed segment element is pivotably mounted and meshes with said toothed segment of said release ring such that said toothed segment element effects a rotation of said release ring; and
said toothed segment element is spring-pretensioned in a first pivot position, which corresponds to a rest position of said release ring, and, through use of said actuating device, said toothed segment element is pivoted out of the first pivot position into a second pivot position which rotates said release ring in an operating position thereof.

11. The coupling device according to claim 10, wherein said toothed segment element is one of a toothed segment wheel and a toothed rod.

12. The coupling device according to claim 10, wherein said actuating device is configured as a Bowden cable device having a first end and a second end, and wherein said Bowden cable device is linked to said toothed segment element at said first end and is configured to be connected to an actuating handle of a vehicle lock at said second end.

13. The coupling device according to claim 7, including:
an entrainment disk rotationally coupled with said driving disk; and
at least one play-compensating spring element connected at one end thereof to said entrainment disk and at another end thereof to said driving disk such that a rotational coupling between said entrainment disk and said driving disk is established via said at least one play-compensating spring element, wherein the rotational coupling allows a relative rotation between said driving disk and said entrainment disk over a given rotation angle in such a manner that as a result of a rotation of said entrainment disk in a direction of rotation of the second position of said control disk, said driving disk is, at least when an end position of said driving disk is reached, pretensioned in a same direction of rotation and a play-compensating further rotation at a rotation angle which maximally corresponds to the given rotation angle is made possible.

14. The coupling device according to claim 13, including connecting devices enabling the relative rotation of said entrainment disk in relation to said driving disk at the given rotation angle.

15. The coupling device according to claim 14, wherein a connecting pin and a longitudinal groove are provided as said connecting devices, said connecting pin is connected to said driving disk, said longitudinal groove is provided on said entrainment disk for receiving the connecting pin such that said longitudinal groove allows a relative movement of said connecting pin corresponding to the rotation angle.

16. The coupling device according to claim 13, including:
a worm; and
said entrainment disk including a worm wheel driven by said motorized driving device via said worm.

17. The coupling device according to claim 13, wherein said entrainment disk includes a spring attaching wheel, said spring attaching wheel is formed with a longitudinal groove and, together with said driving disk, receives said at least one play-compensating spring element.

18. The coupling device according to claim 1, wherein said motorized driving device is configured to be self-locking.

19. The coupling device according to claim 18, wherein said motorized driving device is configured as an electric motor for a motorized driving of one of said driving disk and said the entrainment disk.

20. A vehicle configuration, comprising:
a motor vehicle body having a vehicle structural part and a pivotably mounted body part;
a coupling device for releasably connecting said pivotably mounted body part to said vehicle structural part;
said coupling device including a first coupling element, a second coupling element, a cuboid closing wedge holder, a motorized driving device, and an operative connecting device;
said second coupling element, in a coupled state of said coupling device, being coupled in a play-free manner with said first coupling element;
said first coupling element having two locking bars, said locking bars being mounted so as to be displaceable in relation to one another in a parallel manner, said locking bars being configured as plate-shaped dosing wedges;
said plate-shaped dosing wedges being mounted in said cuboid dosing wedge holder, said plate-shaped dosing wedges having respective wedge faces and having a respective side edge with a respective wedge-shaped cross section for forming said wedge faces;
said motorized driving device, in order to couple said first and said second coupling element, moving said locking bars apart from one another in a motorized manner by using said operative connecting device; and
said second coupling element having two holding jaws, said holding jaws receiving said first coupling element therebetween, said holding jaws having respective keyways with respective wedge faces formed therein such that said plate-shaped dosing wedges are pressed, with said wedge faces of said plate-shaped dosing wedges, into said keyways as a result of said plate-shaped dosing wedges being displaced apart from one another in a motorized manner and thus being movable into abutment with said wedge faces of said keyways.

21. The vehicle configuration according to claim 20, wherein said pivotably mounted body part is a body part selected from the group consisting of a vehicle door, a tailgate, and a hood.

22. The vehicle configuration according to claim 20, wherein:
said operative connecting device for establishing an operative connection between said motorized driving device and said closing wedges of said first coupling element includes a cam disk with two diametrically opposed cam lugs;
said cam disk is mounted in said first coupling element such that, as a result of a rotation with said cam lugs and said closing wedges in operative connection, said closing wedges are pressed into said keyways of said holding jaws;
said operative connecting device includes a control disk, said control disk is connected to said cam disk in a manner fixed against rotation relative thereto;
a stop device limits a rotation of said control disk such that said control disk is rotatable between a first position and a second position, wherein the first position decouples said first and said second coupling element and wherein the second position couples said first and said second coupling element;
an entrainment device is provided, said operative connecting device has a driving disk, said driving disk is connectable to said control disk in a manner fixed against relative rotation through use of said entrainment device;
said entrainment device is disposed in a pivotable and spring-loaded manner on said control disk such that said entrainment device establishes a releasable latching connection to said driving disk such that the latching connection is fixed against relative rotation;
a release ring is provided for an emergency release of said first and said second coupling element, said release ring is disposed axially with respect to said control disk, said release ring has a control cam which can be moved into operative connection with said entrainment device for releasing the latching connection between said entrainment device and said driving disk;
an actuating device is configured to effect a rotation of said release ring out of a rest position into at least one operating position such that by way of the rotation initially the latching connection, at least in the second position of the control disk, with said driving disk is released and said control disk is then rotated, through use of said entrainment device, in a direction of the first position thereof;
said release ring has a toothed segment, a toothed segment element is pivotably mounted and meshes with said toothed segment of said release ring such that said toothed segment element effects a rotation of said release ring, said toothed segment element is spring-pretensioned in a first pivot position, which corresponds to a rest position of said release ring, and, through use of said actuating device, said toothed segment element is pivoted out of the first pivot position into a second pivot position which rotates said release ring in an operating position thereof; and
a vehicle lock with an actuating handle is provided, said actuating device is configured as a Bowden cable device having a first end and a second end, and said Bowden cable device is linked to said toothed segment element at said first end and is connected to said actuating handle of said vehicle lock at said second end.
